(19) United States
(12) Patent Application Publication
(10) Pub. No.: US 2007/0281217 A1
(43) Pub. Date: Dec. 6, 2007

(54) ELECTROLYTE AND BATTERY USING THE SAME

(75) Inventors: Masayuki IHARA, Fukushima (JP); Hiroyuki YAMAGUCHI, Fukushima (JP); Tadahiko KUBOTA, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/757,799

(22) Filed: Jun. 4, 2007

(30) Foreign Application Priority Data
Jun. 5, 2006 (JP) P2006-156637
Jun. 5, 2006 (JP) P2006-156638

(51) Int. Cl. H01M 10/40

(52) U.S. Cl. 429/327; 429/337; 429/336; 429/340; 429/329

(57) ABSTRACT

An electrolyte and battery using same is provided. The electrolyte comprising at least one of a compound represented by Formula 1, wherein, R1, P2, R3, and R4 represent a hydrogen group, or a methyl group and an ethyl group; X, Y, and Z represent sulfur (S) or oxygen (O) or Formula 2, wherein, R1 and R2 represent a hydrogen group, a halogen group, or a methyl group and an ethyl group, or groups in which a part of hydrogen thereof is substituted by a halogen group; X, Y, and Z represent sulfur (S) or oxygen (O), which can retain chemical stability at high temperatures. Use of the electrolyte allows a battery to have excellent characteristics in a hot environment.

### CROSS REFERENCES TO RELATED APPLICATIONS

The present application claims priority to Japanese Patent Application JP 2006-156638 filed in the Japanese Patent Office on Jun. 5, 2006 and Japanese Patent Application JP 2006-156637 field in the Japanese Patent Office on Jun. 5, 2006, the entire contents of which is being incorporated herein by reference.

### BACKGROUND

The present application relates to an electrolyte and a battery using the same, more particularly, to a nonaqueous electrolyte containing a nonaqueous solvent and an electrolyte salt and a nonaqueous electrolyte battery using the same.

Recently, portable electronic equipment typified by camera-integrated VTRs (videotape recorder), portable telephone equipment or laptop computers is widely used, and there is a strong need for size reduction, weight reduction, and a long continuous drive of the portable electronic equipment. In response to the need, research and development for the improvement of the energy density of a battery, especially a secondary battery as a portable power source for such equipment has been actively proceeding. Among them, a lithium-ion secondary battery or a lithium metal secondary battery is expected to improve the energy density since when these batteries are used a greater energy density is obtained compared to that of a lead battery which is a nonaqueous-electrolytic solution secondary battery in the past and a nickel-cadmium battery.

The lithium-ion secondary battery or the lithium metal secondary battery is widely used, because their electrolytes in which LiPF₆ as an electrolyte salt is dissolved in a carbonate nonaqueous solvent, such as propylene carbonate or diethyl carbonate have a high electric conductivity and a stable electric potential (See Japanese Patent No. 3294400).

### SUMMARY

However, these days, as there has been increasing use of portable electronic equipment, it is more often under high temperatures during transportation or use. As a result, the battery characteristics is decreased, which has become a problem. Consequently, development of an electrolyte or a battery which can show an excellent characteristics not only at room temperature but also at high temperatures has been desired.

Therefore, it is desirable to provide an electrolyte capable of improving the battery characteristics at high temperatures and a battery using the same.

According to an embodiment, there is provided that an electrolyte having at least one of a compound represented by Formula 1 or 2;

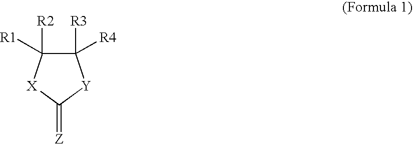

wherein, R1, R2, R3, and R4 represent a hydrogen group, or a methyl group and an ethyl group. X, Y, and Z represent sulfur (S) or oxygen (O), where the case where all of X, Y, and Z are sulfur (S), i.e., (X═Y=Z=S) and the case where all of X, Y, and Z are oxygen (O), i.e., (X═Y=Z=O) are excluded;

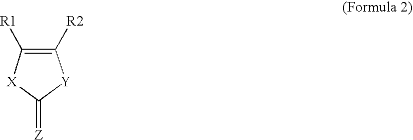

wherein, R1 and R2 represent a hydrogen group, a halogen group, or a methyl group and an ethyl group, or groups in which a part of hydrogen is substituted by a halogen group. X, Y, and Z represent sulfur (S) or oxygen (O), where all of X, Y, and Z are sulfur (S), i.e., (X═Y=Z=S) and the case where all of X, Y, and Z are oxygen (O), i.e., (X═Y=Z=O) are excluded.

According to an embodiment, there is provided that a battery having a cathode and an anode, and an electrolyte, in which the electrolyte includes at least one of a compound represented by Formula 3 and a compound represented by Formula 4;

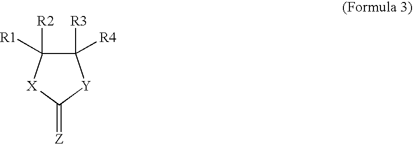

wherein, R1, R2, R3, and R4 represent a hydrogen group, or a methyl group and an ethyl group. X, Y, and Z represent sulfur (S) or oxygen (O), where the case where all of X, Y, and Z are sulfur (S), i.e., (X═Y=Z=S) and the case where all of X, Y, and Z are oxygen (O), i.e., (X═Y=Z=O) are excluded;

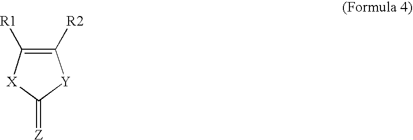

wherein, R1 and R2 represent a hydrogen group, a halogen group, or a methyl group and an ethyl group, or groups in which a part of hydrogen is substituted by a halogen group. X, Y, and Z represent sulfur (S) or oxygen (O), where all of X, Y, and Z are sulfur (S), i.e., (X═Y=Z=S) and the case where all of X, Y, and Z are oxygen (O), i.e., (X═Y=Z=O) are excluded.

According to the embodiment, there is provided an electrolyte capable of improving chemical stability under high-temperature environment since the electrolyte includes at least one of a compound represented by Formula 1 or 2.

According to the embodiment, there is provided an electrolyte capable of suppressing decomposition reaction of electrolyte in an anode under high-temperature environment and showing an excellent characteristic at high temperatures since the electrolyte includes at least one of a compound represented by Formula 3 or 4.

According to the embodiment, there is provided an electrolyte capable of improving chemical stability under high-temperature environment. Further according to the embodiment, there is provided a battery using the electrolyte which is capable of showing an excellent characteristics at high temperatures.

Additional features and advantages are described herein, and will be apparent from, the following Detailed Description and the figures.

### BRIEF DESCRIPTION OF THE FIGURES

FIG. 1 is a cross-sectional view showing a structure of the first example of a secondary battery using an electrolyte according to an embodiment;

FIG. 2 is a partly enlarged cross-sectional view illustrating a part of a spiral electrode body in a secondary battery shown in FIG. 1;

FIG. 3 is an exploded perspective view showing a structure of the second example of a secondary battery using an electrolyte according to an embodiment;

FIG. 4 is a cross-sectional view taken along line I-I of a spiral electrode body shown in FIG. 3; and

FIG. 5 shows an example of the peaks corresponding to an anode material prepared in Examples which is obtained by X-ray photoelectron spectroscopy.

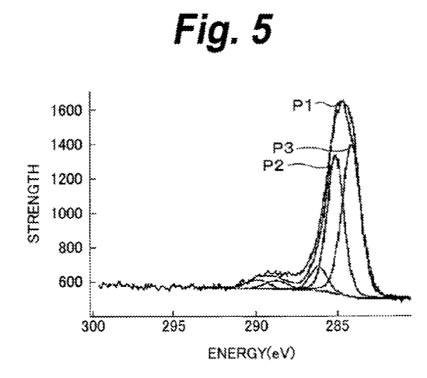

### DETAILED DESCRIPTION

The present application will be described in further detail below including reference to the accompanying drawings according to an embodiment. An electrolyte to according to an embodiment includes the so-called liquid electrolytic solution containing, for example, a solvent and an electrolyte salt dissolved in a solvent. A nonaqueous solvent such as an organic solvent is preferably used as a solvent and the solvent contains at least one of a compound represented by Formula 5 or 6.

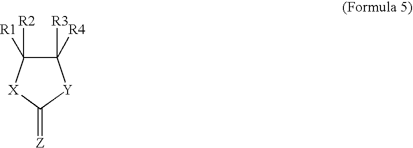

wherein, R1, R2, R3, and R4 represent a hydrogen group, or a methyl group and an ethyl group. X, Y, and Z represent sulfur (S) or oxygen (O), where the case where all of X, Y, and Z are sulfur (S), i.e., (X═Y=Z=S) and the case where all of X, Y, and Z are oxygen (O), i.e., (X═Y=Z=O) are excluded.

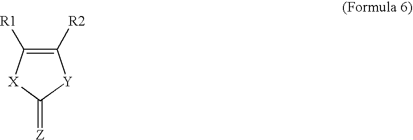

wherein, R1 and R2 represent a hydrogen group, a halogen group, or a methyl group and an ethyl group, or groups in which a part of hydrogen is substituted by a halogen group. X, Y, and Z represent sulfur (S) or oxygen (O), where all of X, Y, and Z are sulfur (S), i.e., (X═Y=Z=S)and the case where all of X, Y, and Z are oxygen (O), i.e., (X═Y=Z=O) are excluded.

This solvent can inhibit decomposition reaction of electrolytic solution at high temperatures since it contains at least one of a compound represented by Formula 5 or 6. Therefore, when the solvent is used for a battery, the cycling characteristics at high temperatures can be improved and the high temperature storage stability can also be improved. Therefore, an excellent characteristics can be obtained even when a battery used this solvent is left under high temperatures or used under high temperatures.

Examples of a compound represented by Formula 5 include compounds represented by (7-1) to (7-12) in Formula 7. Examples of a compound represented by Formula 6 include compounds represented by (8-1) to (8-23) in Formula 8.

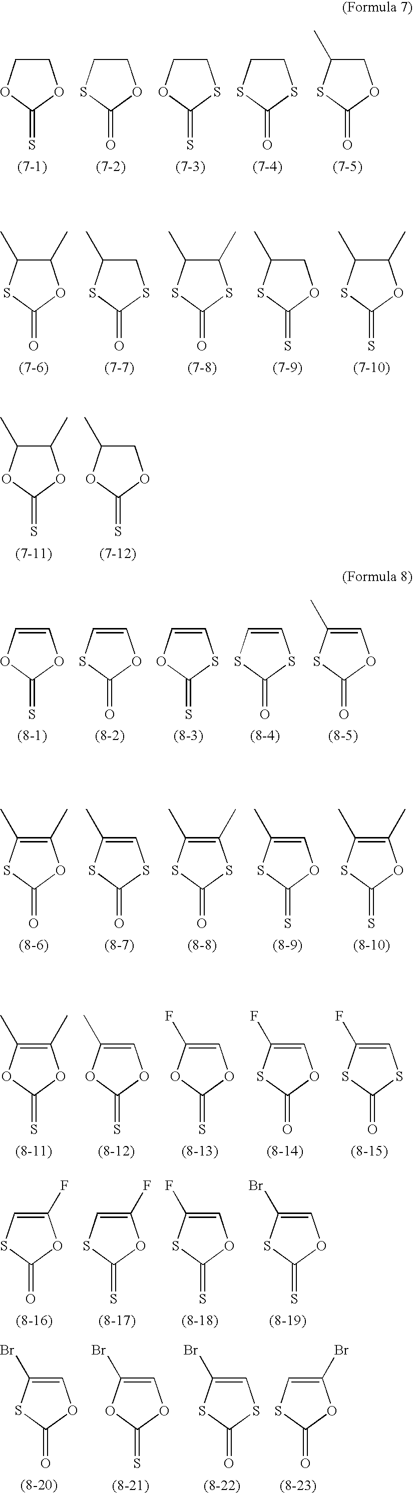

Among compounds represented by Formula 5, a compound represented by Formula 9 is preferable from a viewpoint that more excellent high temperature characteristics can be obtained. Among compounds represented by Formula 6, a compound represented by Formula 10 is preferable from a viewpoint that more excellent high temperature characteristics can be obtained.

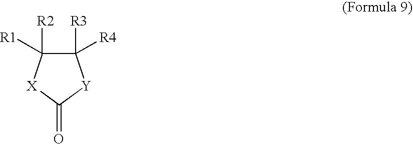

wherein, R1, R2, R3, and R4 represent a hydrogen group, or a methyl group and an ethyl group. X and Y represent sulfur (S) or oxygen (O), provided that the case where all of X and Y are oxygen (O), i.e., (X═Y=O) is excluded.

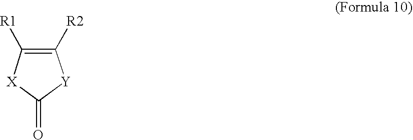

wherein, R1 and R2 represent a hydrogen group, a halogen group, or a methyl group and an ethyl group, or groups in which a part of hydrogen is substituted by a halogen group. X and Y represent sulfur (S) or oxygen (O), provided that the case where all of X and Y are oxygen (O), i.e., (X═Y=O) is excluded.

The content of at least one of a compound represented by Formula 5 or Formula 6 is preferably 0.01% by weight or more and less than 5% by weight to a solvent from a viewpoint that more excellent high temperature characteristics can be obtained.

Preferably, a solvent further contains a cyclic carbonate having an unsaturated bond such as vinylene carbonate (VC) and vinyl ethylene carbonate (VEC). This is because the chemical stability of an electrolytic solution can be improved under high-temperature environment and an excellent high temperature characteristics can be obtained. Further, the content of a cyclic carbonate compound having an unsaturated bond is preferably 0.01% by weight or more and 5% by weight or less to a solvent.

Preferably, a solvent further contains halogenated cyclic carbonate represented by Formula 12 in which some or all of hydrogen atoms of R1, R2, R3, and R4 in a cyclic carbonate represented by Formula 11 may be substituted by a fluorine (F) atom, a chlorine (Cl) atom, or a bromine (Br) atom. This is because the solvent can further inhibit decomposition reaction of electrolytic solution at high temperatures. Therefore, when the solvent is used for a battery, the cycling characteristics can be improved and the high temperature storage stability and high-temperature operability can also be improved. Therefore, an excellent characteristics can be further obtained even when the battery used this solvent is left under high temperatures or used under high temperatures.

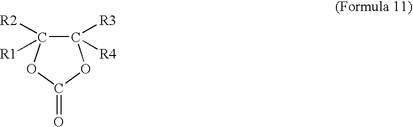

wherein, R1, R2, R3, and R4 are a hydrogen atom, a methyl group, or an ethyl group.

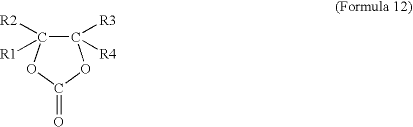

wherein, R1, R2, R3, and R4 represent a hydrogen group, a halogen group, or a methyl group and an ethyl group, or groups in which a part of hydrogen thereof is substituted by a halogen group and at least one group among them has a halogen group.

Examples of a compound represented by Formula 12 include compounds represented by (13-1) to (13-23) in Formula 13.

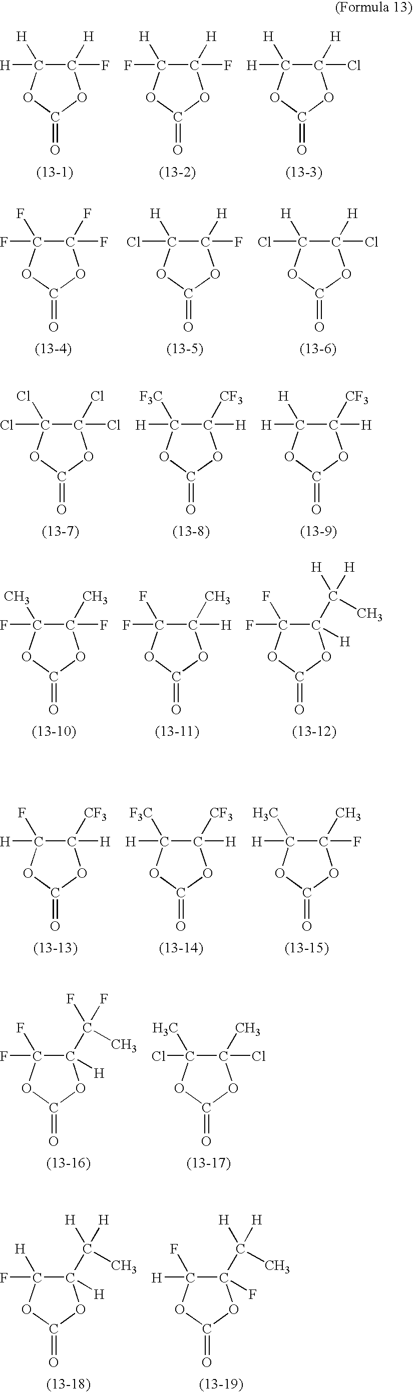

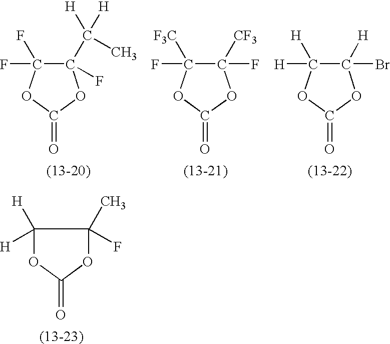

A solvent contains at least one of 4-fluoro-1,3-dioxolane-2-on represented by (13-1) in Formula 13 and 4,5-difluoro-1,3-dioxolane-2-on represented by (13-2) in Formula 13 among the compounds represented by Formula 12. This is because an excellent high temperature characteristics can be further obtained. Preferably, 4,5-difluoro-1,3-dioxolane-2-on is a trans-structure. This is because an excellent high temperature characteristics can be obtained.

Various nonaqueous solvents used in the past may be mixed to use. Specific examples of such a nonaqueous solvent include ethylene carbonate, propylene carbonate, butylene carbonate, vinylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, ethyl propionate, dimethyl carbonate, ethyl methyl carbonate, diethyl carbonate, acetonitrile, glutaronitrile, adiponitrile, methoxy acetonitrile, 3-methoxy propionitrile, N,N-dimethyl formamide, N-methyl pyrrolizinone, N-methyl oxazolidinone, N,N′-dimethyl imidazolidinone, nitromethane, nitroethane, sulfolane, dimethyl sulfoxide, and trimethyl phosphate, but it is not particularly limited thereto. These solvents alone may be mixed for use. A plurality of the solvents may be mixed for use. When a plurality of the solvents may be mixed for use, a solvent having a high dielectric constant (30 or more) is preferably mixed with a solvent having a low viscosity (1 mPa·s or less) and used. This is because a high ion-conductivity can be thereby obtained.

Furthermore, in order to achieve superior charge/discharge capacity characteristics and charge/discharge cycling characteristics, a solvent containing at least one selected from the group consisting of ethylene carbonate, propylene carbonate, vinylene carbonate, dimethyl carbonate, and ethyl methyl carbonate is preferably used.

(Electrolyte Salt)

Examples of an electrolyte salt preferably include a light metal salt represented by Formula 14. This is because the light metal salt represented by Formula 14 forms a stable coating on the surface of an anode 22, which allows for inhibiting decomposition reaction of a solvent. The light metal salt represented by Formula 14 may be used alone, or two or more of them may be mixed for use.

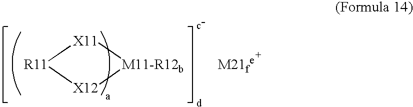

wherein, R11 represents groups shown in Formula 15, 16, or 17; R12 represents a halogen group, an alkyl group, an alkyl halide group, an aryl group, or an aryl halide group; X11 and X12 represent oxygen (O) or sulfur (S), respectively; M11 represents a transition metal element or an element of Group 3B, 4B or 5B in the short-form periodic table; M21 represents an element of Group 1A or 2A in the short-form periodic table, or an aluminum (Al); a is an integer of 1 to 4; b is an integer of 0 to 8; c, d, e, and f are integers of 1 to 3, respectively.

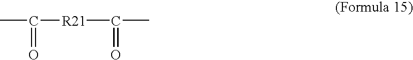

wherein, R21 represents an alkylene group, an alkylene halide group, an arylene group, or a arylene halide group.

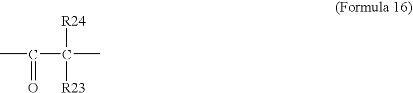

wherein, R23, and R24 represent an alkyl group, an alkyl halide group, an aryl group, or an aryl halide group.

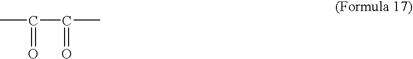

A compound represented by Formula 18 is preferable as a light metal salt represented by Formula 14.

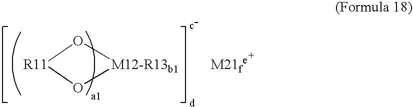

wherein, R11 represents groups shown in Formula 19, 20, or 21; M12 represents phosphorus (P) or boron (B); R13 represents a halogen group; M21 represents an element of Group 1A or 2A in the short-form periodic table, or an aluminum (Al); a1 is an integer of 1 to 4; b1 is an integer of 0, 2 or 4; c, d, e, and f are integers of 1 to 3, respectively.

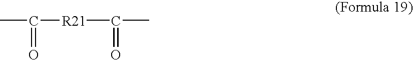

wherein, R21 represents an alkylene group, an alkylene halide group, an arylene group, or a arylene halide group.

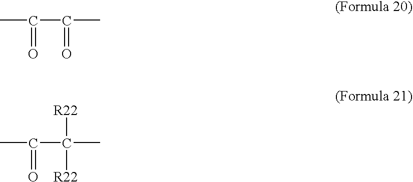

wherein, R22 represents an alkyl group, an alkyl halide group, an aryl group, or an aryl halide group.

Examples of a light metal salt represented by Formula 18 include lithium difluoro[oxolato-O,O′]borate represented by Formula 22, lithium difluorobis[oxolato-O,O′]phosphate represented by Formula 23, lithium difluoro[3,3,3-trifluoro-2-oxide 2-trifluoromethylpropionate(2-)-O,O′]borate represented by Formula 24, lithium bis[3,3,3-trifluoro-2-oxide 2-trifluoromethylpropionate(2-)-O,O′] represented by Formula 25, lithium tetrafluoro[oxolato-O,O′]borate represented by Formula 26, and lithium bis[oxolato-O,O′]borate represented by Formula 27.

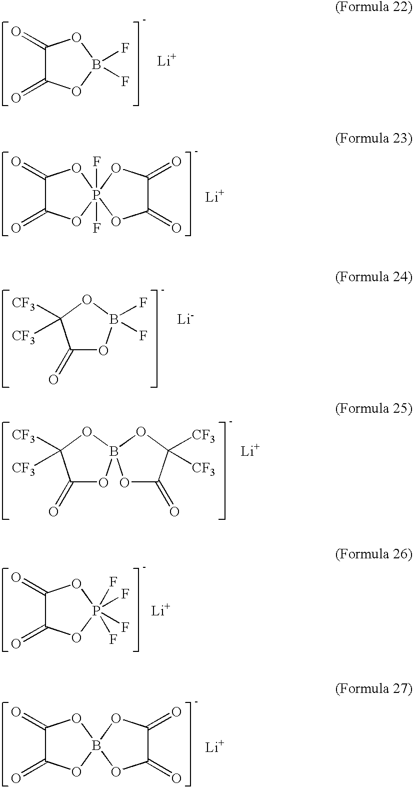

As to the electrolyte salt, in addition to the light metal salt as described above, any one of other light metal salts or two or more thereof may be mixed for use. This is because the battery characteristics such as storage stability can be improved and the internal resistance can be reduced.

Other examples of a light metal salt include a lithium salt represented by Formula 28 such as LiB(C₆H₅)₄, LiCH₃SO₃, LiCF₃SO₃, LiAlCl₄, LiSiF₆, LiCl, LiBr, LiPF₆, LiBF₄, LiB(OCOCF₃)₄, LiB(OCOC₂F₅)₄, LiClO₄, LiAsF₆, LiN(CF₃SO₂)₂, LiN(C₂F₅SO₂)₂ or LiN(C₄F₉SO₂)(CF₃SO₂), or a lithium salt represented by Formula 29 such as LiC(CF₃SO₂)₃.

Other examples of a light metal salt include a lithium salt represented by Formula 30 and preferable examples of the lithium salt represented by Formula 30 include 1,2-perfluoroethanedisulfonyl imide lithium represented by Formula 31, 1,3-perfluoropropanedisulfonyl imide lithium represented by Formula 32, 1,3-perfluorobutanedisulfonyl imide lithium represented by Formula 33, 1,4-perfluorobutanedisulfonyl imide lithium represented by Formula 34. Furthermore, a lithium salt such as perfluoro heptanedioic acid imide lithium represented by Formula 35 is included.

LiN(CₘF₂ₘ₊₁SO₂)(CₙF₂ₙ₊₁SO₂) (Formula 28)

wherein, m and n are one or more integers.

LiC(CₚF₂ₚ₊₁SO₂)(C_{q}F_{2q+1}SO₂)(CᵣF₂ᵣ₊₁SO₂) (Formula 29)

wherein, p, q, and r are one or more integers.

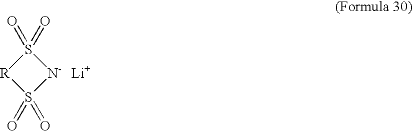

wherein, R represents a linear or branched perfluoro alkylene group having 2 to 4 carbon atoms.

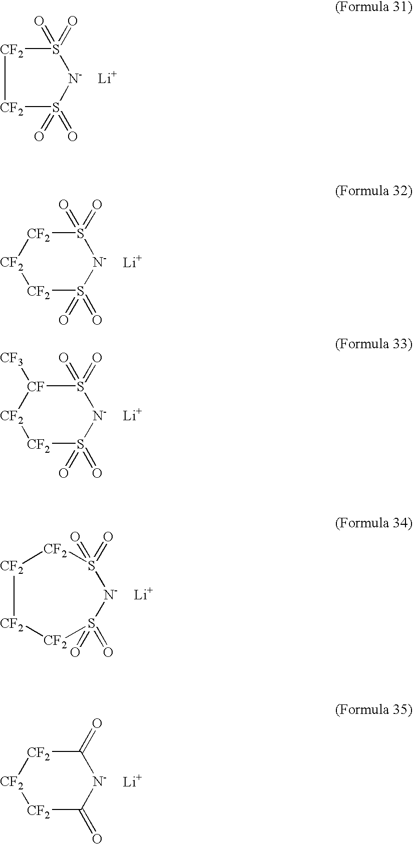

Among these, when at least one of the group consisting of LiPF₆, LiBF₄, LiClO₄, LiAsF₆, a lithium salt represented by Formula 28, a lithium salt represented by Formula 29, a lithium salt represented by Formula 30 is included, a higher effect can be obtained and a high electric conductivity can be obtained, so it is preferable. It is further preferable that at least one of the group consisting of LiPF₆, LiBF₄, LiClO₄, LiAsF₆, a lithium salt represented by Formula 28, a lithium salt represented by Formula 29, and a lithium salt represented by Formula 30 is mixed for use.

The content (concentration) of an electrolyte salt is preferably within a range from 0.3 mol/kg to 3.0 mol/kg to a solvent. This is because it is difficult to obtain sufficient battery characteristics due to very low ionic conductivity. Referring to the content, the content of a light metal salt represented by Formula 14 is preferably within a range from 0.01 mol/kg to 2.0 mol/kg to a solvent. This is because a higher effect can be obtained within the range.

Here, a gel-like electrolyte in which a electrolytic solution is retained by a polymeric compound may be used as an electrolyte. The composition and structure of a polymeric compound are not particularly limited as long as the gel-like electrolyte has ionic conductivity of 1 mS/cm or more at room temperature. An electrolytic solution (namely, a liquid solvent and an electrolyte salt) is as described above. Examples of a polymeric compound include polyacrylonitrile, polyvinylidene fluoride, copolymers of polyvinylidene fluoride and polyhexafluoro propylene, polytetrafluoroethylene, polyhexafluoro propylene, polyethylene oxide, polypropylene oxide, polyphosphazen, polysiloxane, polyvinyl acetate, polyvinyl alcohol, polymethyl methacrylate, polyacrylic acid, polymethacrylic acid, styrene-butadiene rubber, nitrile-butadiene rubber, polystyrene, or polycarbonate. Particularly, from a viewpoint of electrochemical stability, it is desirable to use a polymeric compound with the structure of polyacrylonitrile, polyvinylidene fluoride, polyhexafluoro propylene, or polyethylene oxide. It is preferable that an amount of the polymeric compound equivalent to 5% by mass or more and less than 50% by mass of the electrolyte solution is usually added to the electrolyte solution, however it varies depending on compatibility between the electrolyte solution and the polymeric compound.

In addition, the content of an electrolyte salt is the same as that of an electrolytic solution. The term “solvent” used herein widely includes not only a liquid-state solvent but also a solvent capable of dissociating electrolyte salt and having ion conductivity. Therefore, when a polymeric compound having ion conductivity is used, the polymeric compound is also considered as the solvent.

It is possible to fabricate secondary batteries such as lithium batteries having various shape and size using the above-mentioned electrolyte. The first example of a battery using an electrolyte according to an embodiment will be described below.

(First Example of Battery)

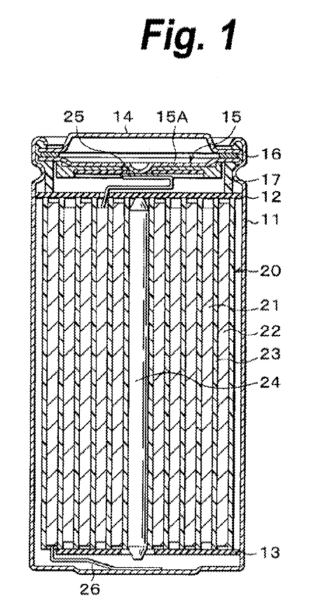

FIG. 1 shows a cross-sectional structure of the first example of a secondary battery using an electrolyte according to an embodiment. This secondary battery is the so-called cylindrical shape and includes a spiral electrode body 20 in which a band-like cathode 21 and a band-like anode 22 are laminated and wound via a separator 23 in a hollow cylindrical battery can 11.

The battery can 11 is made of iron (Fe) plated with nickel (Ni) and one end thereof is closed, and the other end is opened. Inside the battery can 11, a pair of insulating plates 12 and 13 are arranged to sandwich the spiral electrode body 20 perpendicularly to a periphery surface thereof.

A battery lid 14, and a safety valve mechanism 15 and a positive temperature coefficient (PTC) element 16 which are positioned inside the battery lid 14, are mounted in the open end of the battery can 11 by caulking via a gasket 17 to seal the inside of the battery can 11.

The battery lid 14 is made of the same material as the battery can 11. The safety valve mechanism 15 is electrically connected to the battery lid 14 through a PTC element 16. When an internal pressure of the battery becomes a certain value or higher due to internal short circuit or heating from outside, a disk plate 15A is inverted to cut the electric connection between the battery lid 14 and the spiral electrode body 20.

The PTC element 16 restricts electric currents, when its resistance increases with an increase in temperature, to prevent unusual heat generation due to high electric currents. The gasket 17 is made of an insulating material and asphalt is applied to a surface thereof.

The spiral electrode body 20 is wound centering on a center pin 24. A cathode lead 25 containing aluminum (Al) or the like is connected to the cathode 21 of the spiral electrode body 20, and an anode lead 26 containing nickel (Ni) or the like is connected to the anode 22. The cathode lead 25 is welded to the safety valve mechanism 15 to be electrically connected with the battery lid 14. The anode lead 26 is welded to the battery can 11 to be electrically connected.

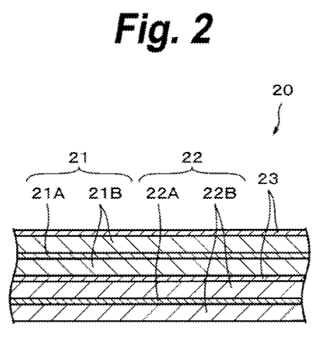

FIG. 2 is a partially enlarged view of the spiral electrode body 20 shown in FIG. 1. The cathode 21 has a structure, for example, where a cathode current collector 21A has a pair of opposing surfaces and cathode active material layers 21B are located on both sides thereof. In addition, the cathode active material layer 21B may be located only on one side of the cathode current collector 21A. The cathode current collector 21A is made of metal foil such as aluminum foil, nickel foil, or stainless steel foil. The cathode active material layer 21B is composed to contain a cathode material capable of adsorbing and releasing lithium (Li) which is an electrode reaction substance, for example, as a cathode active material.

Preferable examples of a cathode material capable of adsorbing and releasing lithium (Li) include lithium cobaltate and lithium nickelate, or a solid solution including thereof (Li(NiₓCo_{y}Mn_{z})O₂) (values of x, y, and z are 0<x<1,0<y<1,0<z<1, and x+y+z=1.) or lithium composite oxides such as manganese spinel (LiMn₂O₄), or a phosphoric acid compound having the olivine structure, such as lithium iron phosphate (LiFePO₄). This is because a high energy density can be obtained.

In addition, examples of a cathode material capable of adsorbing and releasing lithium (Li) include oxides such as titanium oxide, vanadium oxide, or manganese dioxide, disulfides such as iron disulfide, titanium disulfide, or molybdenum disulfide, and conductive polymers such as polyaniline or polythiophene. The cathode material may be used alone, or two or more of them may be mixed for use.

The cathode active material layer 21B contains a conductive agent and further contains a binding agent, if necessary. Examples of a conductive agent include carbon materials such as graphite, carbon black and ketjen black. One or two or more of the materials are used. Besides the carbon materials, a metal material, a conductive polymer material, or the like can be also used as long as the material has conductivity.

Examples of the binder include synthetic rubbers such as styrene-butadiene-based rubbers, fluororubbers, and ethylene propylene diene rubbers, and polymeric materials such as polyvinylidene fluoride. One or two or more of the materials are used. For example, when the cathode 21 and the anode 22 are wound as shown in FIG. 1, it is preferable to use styrene-butadiene rubber or fluororubber as a binder, which have excellent flexibility.

The anode 22 has, for example, a structure in which an anode active material layer 22B is provided on both faces of an anode current collector 22A having a pair of opposing faces. The anode active material layer 22B may be provided only on one face of the anode current collector 22A.

The anode current collector 22A is made of, for instance, metal foil such as copper foil, nickel foil, or stainless steel foil having excellent electrochemical stability, electric conductivity and mechanical strength. Particularly, the copper foil is the most preferable since it has high electric conductivity.

The anode current collector 22A may preferably include a metal material including at least one of a metal element not forming an intermetallic compound with lithium (Li). When an intermetallic compound is formed with lithium, expansion and shrinkage occur due to charge and discharge, structure is destructed, and current collection characteristics are lowered. In addition, the ability to support the anode active material layer 22B is lowered, therefore the anode active material layer 22B may drop out of the anode current collector 22A. Metal materials in the specification include not only a simple substance of metal elements but also an alloy which is composed of two or more metal elements or one or more metal elements and one or more metalloid elements. Examples of a metal element not forming an intermetallic compound with lithium (Li) include copper (Cu), nickel (Ni), titanium (Ti), iron, or chromium (Cr).

The anode active material layer 22B include any one, or two or more of the anode material capable of adsorbing and releasing lithium (Li) as an anode active material and may also include the same binding agent as the cathode active material layer 21B, if necessary.

Examples of an anode material capable of adsorbing and releasing lithium (Li) include a carbon material, metallic oxides, or a polymeric compound. Examples of a carbon material include an easy-graphitizable carbon, a non-easy-graphitizable carbon having a (002) surface with spacing of 0.37 nm or more, or graphite having a (002) surface with spacing of 0.340 nm or less. Specific examples thereof include pyrolytic carbons, cokes, graphites, glassy carbons, organic polymer compound sintered bodies, carbon fiber or activated carbon. Examples of such a coke include pitch coke, needle coke, or petroleum coke. Organic polymer compound sintered bodies are obtained by sintering and carbonizing polymeric compounds such as a phenol resin and a furan resin at suitable temperatures. Examples of a metallic oxide include iron oxide, ruthenium oxide, or molybdenum oxide. Examples of a polymeric compound include polyacethylene or polypyrrole.

The anode active material layer 22B may include at least one of an anode material of the group consisting of the simple substance, alloy, and compound of a metal element capable of adsorbing and releasing lithium (Li) (an electrode reaction substance), and the simple substance, alloy, and compound of a metalloid element capable of adsorbing and releasing lithium (Li) as an anode active material. Thus, a high energy density can be obtained. These anode materials may be used together with the carbon materials described above. The carbon materials are desirable because there is very little change of the crystal structure thereof produced in charge and discharge, and when they are used together with the anode materials described above, a high energy density and excellent cycling characteristics can be obtained and they also function as a conductive agent. In the specification, an alloy including one or more metallic elements and one or more metalloid elements is included in addition to an alloy including two or more metallic elements. Additionally, a nonmetallic element may be included. Examples of the structures of the materials include a solid solution, an eutectic (eutectic mixture), an intermetallic compound and a concomitant state of two or more of the structures.

Examples of a metal element constituting an anode material or a metalloid element include magnesium (Mg), boron (B), aluminum (Al), gallium (Ga), Indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), or platinum (Pt). These elements may be a crystalline substance or amorphous.

As an alloy or a compound of such a metal element or metalloid element, for example, an alloy or a compound represented by a chemical formula of MaₛMbₜLiᵤ or a chemical formula of MaₚMc_{q}Mdᵣ is included. In these chemical formulas, Ma represents at least one of a metal element and metalloid element capable of forming an alloy with lithium (Li); Mb represents at least one of a metal element and a metalloid element other than lithium (Li) and Ma; Mc represents at least one of a nonmetallic element; Md represents at least one of a metal element and metalloid element other than Ma. Values of s, t, u, p, q, and r are s>0, t≧0, u≧0, p>0, q>0, and r≧0, respectively.

Among these, a simple substance, an alloy, or a compound of a metal element or a metalloid element of Group 4B in the short period periodic table is preferable. A simple substance of silicon (Si) or tin (Sn), or an alloy or a compound thereof is particularly preferable. This is because a simple substance, an alloy, or a compound of silicon (Si) or tin (Sn) is capable of adsorbing and releasing lithium (Li) and the energy density of the anode 22 can be higher as compared with the graphite in the past depending on combination thereof.

Specific examples of such an alloy or compound include SiB₄, SiB₆, Mg₂Si, Ni₂Si, TiSi₂, MoSi₂, CoSi₂, NiSi₂, CaSi₂, CrSi₂, CU₅Si, FeSi₂, MnSi₂, NbSi₂, TaSi₂, VSi₂, WSi₂, ZnSi₂, SiC, Si₃N₄, Si₂N₂O, SiOᵥ (0<v≦2), SnO_{w} (0<w≦2), SnSiO₃, LiSiO, LiSnO, Mg₂Sn, or an alloy including tin (Sn) and cobalt (Co).

Among others, a CoSnC containing material in which tin (Sn), cobalt (Co), and carbon (C) are included as a constituting element, the carbon content is 9.9% by mass or more to 29.7% by mass or less, and the ratio of cobalt (Co) to the total of tin (Sn) and cobalt (Co) (Co/(Sn+Co)) is 30% by mass or more to 70% by mass or less is preferable as an anode material. This is because a high energy density and excellent cycling characteristics can be obtained in the composition range.

This CoSnC containing material may further contain other constituting elements, if necessary. Other preferable examples of a constituting element include silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga), or bismuth (Bi) and two or more thereof may be included. This is because the capacity or cycling characteristics can be further improved.

The CoSnC containing material includes a phase containing tin (Sn), cobalt (Co) and carbon (C), and the phase preferably has a low crystalline structure or an amorphous structure. Moreover, in the CoSnC containing material, at least a part of carbon as a constituting element is preferably bonded to a metal element or a metalloid element as another constituting element. It is considered that a decline in the cycling characteristics is caused by aggregation or crystallization of tin (Sn) or the like, and when carbon is bonded to another element, such aggregation or crystallization can be inhibited.

As a measuring method for determining the bonding state of an element, for example, X-ray photoelectron spectroscopy (XPS) is used. In the XPS, the peak of the Is orbit (C1s) of carbon in the case of graphite is observed at 284.5 eV in an apparatus in which energy calibration is performed so that the peak of the 4f orbit (Au4f) of a gold atom is observed at 84.0 eV. Moreover, the peak of C1s of the surface contamination carbon is observed at 284.8 eV. On the other hand, in the case where the charge density of the carbon element increases, for example, in the case where carbon is bonded to a metal element or a metalloid element, the peak of C1s is observed in a region lower than 284.5 eV. In other words, in the case where the peak of the composite wave of C1s obtained in the CoSnC containing material is observed in a region lower than 284.5 eV, at least a part of carbon included in the CoSnC containing material is bonded to the metal element or the metalloid element which is another constituting element.

Moreover, in the XPS measurement, for example, the peak of C1s is used to correct the energy axis of a spectrum. In general, surface contamination carbon exists on a material surface, so the peak of C1s of the surface contamination carbon is fixed at 284.8 eV, and the peak is used as an energy reference. In the XPS measurement, the waveform of the peak of C1s is obtained as a form including the peak of the surface contamination carbon and the peak of carbon in the CoSnC containing material, so the peak of the surface contamination carbon and the peak of the carbon in the CoSnC containing material are separated through analyzing the waveform through the use of, for example, commercially available software. In the analysis of the waveform, the position of a main peak existing on a lowest binding energy side is used as an energy reference (284.8 eV).

The anode active material layer 22B may be formed by any of a gas phase method, a liquid phase method, a sintering method, or coating. Alternatively, two or more of these methods may be used in combination. The sintering method involves a process in which a particulate anode active material is mixed with a binding agent or a solvent to fabricate and then it is subjected to heat-treatment at a temperature higher than the melting point of a binding agent.

These methods are preferable because the anode active material layer 22B may be alloyed with the anode current collector 22A on at least a part of the interface at the time of formation when the gas phase method, liquid phase method, or sintering method is used. Further, the alloying may be carried out by performing heat-treatment under a vacuum atmosphere or a non-oxidizing atmosphere. Specifically, it is preferable that in the interface, a constituting element of the anode current collector 22A is diffused into the anode active material layer 22B, or a constituting element of an anode active material is diffused into the anode current collector 22A. Alternatively, it is preferable that the constituting element of the anode current collector 22A and the anode active material layer 22B are interdiffused, or the constituting element of the anode active material and the anode current collector 22A are interdiffused with each other. This is because destruction due to expansion and shrinkage of the anode active material layer 22B at the time of charge and discharge can be inhibited and the electron conductivity between the anode active material layer 22B and the anode current collector 22A can be improved.

For example, a physical deposition method or a chemical deposition method is used as the gas phase method. More specifically, a vacuum deposition method, a sputtering method, an ion plating method, a laser ablation method, a thermal CVD (chemical vapor deposition) method, a plasma CVD method or the like can be used. Well-known techniques, such as an electrolytic plating method, an electroless plating method or the like can be used as the liquid phase method. As the sintering method, well-known techniques such as an atmosphere sintering method, a reactive sintering method or a hot press sintering method can be used. In the case of coating, it can be formed in the same manner as that of the cathode 21.

The anode active material layer 22B may be formed with, for example, a lithium metal which is an anode active material. This is because a high energy density can be thereby obtained. The anode active material layer 22B may exist at the time of assembling, or may not exist at the time of assembling, and may be formed of lithium metal precipitated at the time of charge. Alternatively, the anode active material layer 22B is used as a current collector and the anode current collector 22A may be removed.

The separator 23 is formed of, for example, a porous film made of a synthetic resin such as polytetrafluoroethylene, polypropylene or polyethylene, or porous film made of a ceramic. The separator 23 has a structure in which two or more of the porous films are laminated. Particularly, the porous film made of polyolefine is preferable because it is capable of providing excellent protection against shorts and it is contemplated to improve the safety of battery by shutdown effect. Particularly, polyethylene is preferable as a material forming of the separator 23 because the shutdown effect can be obtained within a range from 100° C. to 160° C. and it has excellent electrochemical stability. Polypropylene is also preferable, and other resins which have chemical stability can be used if they are copolymerized or blended with polyethylene or polypropylene.

An electrolytic solution, which is a liquid electrolyte, is impregnated in the separator 23. The electrolytic solution contains a liquid solvent, a nonaqueous solvent such as an organic solvent, and an electrolyte salt dissolved in the nonaqueous solvent. If necessary, various additives may be contained. The liquid nonaqueous solvent is made of, for example, a nonaqueous compound, whose intrinsic viscosity at 25° C. is 10.0 mPa·s or less. A nonaqueous component, whose intrinsic viscosity in a state where the electrolyte salt is dissolved is 10.0 mPa·s or less may be also used. If a plurality of nonaqueous compounds are mixed to form a solvent, it is sufficient that the intrinsic viscosity in the mixed state is 10.0 mPa·s or less.

Subsequently, an example of the production method in accordance with the first example of a battery will be described. First, for example, a cathode active material, a conductive agent, and a binding agent are mixed to prepare a cathode mixture. The cathode mixture is dispersed in a solvent such as N-methyl-2-pyrrolidone to provide a paste-like cathode mixture slurry. Subsequently, the cathode mixture slurry is applied to the cathode current collector 21A, the solvent is dried, and then the cathode active material layer 21B is formed using compression molding with a roll presser or the like. Thus, the cathode 31 is obtained.

For example, an anode active material and a binding agent are mixed to prepare an anode mixture. The anode mixture is dispersed in a solvent such as N-methyl-2-pyrrolidone to provide a paste-like anode mixture slurry. Subsequently, the anode mixture slurry is applied to the anode current collector 22A, the solvent is dried, and then the anode active material layer 22B is formed using compression molding with a roll presser or the like. Thus, the anode 22 is obtained.

Then, the cathode lead 25 is fixed to the cathode current collector 21A with welding or the like, and the anode lead 26 is fixed to the anode current collector 22A with welding or the like. Thereafter, the cathode 21 and the anode 22 are wound sandwiching the separator 23 therebetween, a tip portion of the cathode lead 25 is welded to the safety valve mechanism 15, a tip portion of the anode lead 26 is welded to the battery can 11, and the wound cathode 21 and anode 22 are sandwiched between a pair of the insulating plates 12 and 13 and are housed inside the battery can 11. After housing the cathode 21 and anode 22 inside the battery can 11, the electrolytic solution is injected into the battery can 11 to impregnate the separator 23. Next, the battery lid 14, the safety valve mechanism 15, and the PTC element 16 are caulked and fixed to an opening end of the battery can 11 through the gasket 17. Thus, the secondary battery shown in FIG. 2 is obtained.

When the secondary battery is charged, lithium ion is released from the cathode active material layer 21B and the lithium (Li) contained in the anode active material layer 22B is adsorbed into an anode material capable of adsorbing and releasing via an electrolytic solution. When the secondary battery is discharged, a lithium ion in which the lithium (Li) contained in the anode active material layer 22B is adsorbed into an anode material capable of adsorbing and releasing is released and adsorbed into the cathode active material layer 21B via an electrolytic solution.

(Second Example of Battery)

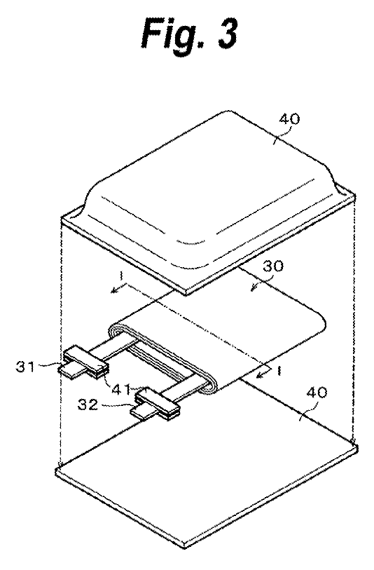

Subsequently, the second example of a battery will be described. FIG. 3 is a cross-sectional view showing a structure example of the second example of a battery. The secondary battery has a spiral electrode body 30 on which a cathode lead 31 and an anode lead 32 are mounted in a film-like exterior member 40, therefore reduction in size, weight, and thickness can be realized.

The cathode lead 31 and the anode lead 32 are drawn, respectively from the inside of the exterior member 40 toward the outside, for example, in the same direction. The cathode lead 31 and the anode lead 32 are made of metallic materials such as aluminum (Al), copper (Cu), nickel (Ni), or stainless steel (SUS), respectively. The respective leads are formed like a thin plate shape or a net shape.

The exterior member 40 is formed of, for example, the aluminum laminated film having a rectangular shape in which a nylon film, an aluminum foil, and a polyethylene film are laminated in this order. Exterior member 40 is arranged, for example, so that the spiral electrode body 30 is opposed to the polyethylene film. The respective outer edges are bonded by welding or adhesives. An adherent film 41 for preventing outside air from entering is inserted between the exterior member 40 and the cathode lead 31, and between the exterior member 40 and the anode lead 32. The adherent film 41 is formed of a material having adhesion to the cathode lead 31 and the anode lead 32, for example, polyethylene, polypropylene, modified polyethylene, or polyolefin resin such as modified polypropylene.

Exterior member 40 may be formed of a laminate film having other structures, a polymer film such as polypropylene, or a metal film in place of the above-mentioned aluminum laminated film.

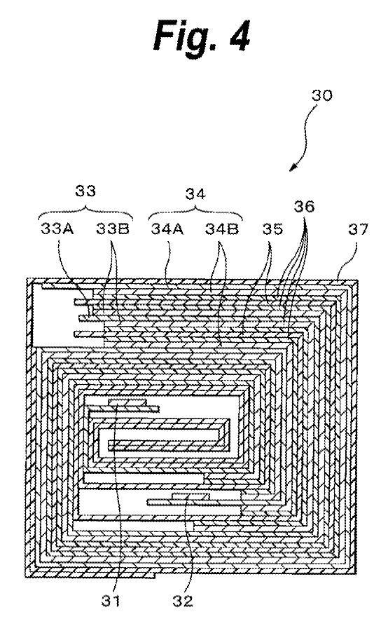

FIG. 4 is a cross-sectional view taken along line I-I of the spiral electrode body 30 shown in FIG. 3. In the spiral electrode body 30, the cathode 33 and the anode 34 are laminated via a separator 35 and an electrolyte layer 36 and wound. The outermost periphery thereof is protected by a protective tape 37.

The cathode 33 has a structure in which the cathode active material layer 33B is formed on one side or both sides of the cathode current collector 33A. The anode 34 has a structure in which the anode active material layer 34B is formed on one side or both sides of the anode current collector 34A. The anode 34 is arranged so that the anode active material layer 34B is opposed to the cathode active material layer 33B. The structures of the cathode current collector 33A, the cathode active material layer 33B, the anode current collector 34A, the anode active material layer 34B, and the separator 35 are the same as the structures of the cathode current collector 21A, the cathode active material layer 21B, the anode current collector 22A, the anode active material layer 22B, and separator 23 which are described in the first example, respectively.

The electrolyte layer 36 contains an electrolytic solution and a polymeric compound containing an electrolytic solution as a holding body and is the so-called gel layer. The gel electrolyte layer 36 is preferable because a high ionic conductivity can be obtained and liquid leakage of a battery can be prevented. The electrolyte may be used as a liquid electrolyte as it is without allowing a polymeric compound to contain an electrolytic solution.

Subsequently, an example of the production method in accordance with the second example of a battery will be described. First, a precursor solution containing a solvent, an electrolyte salt, a polymeric compound, and a mixed solvent is applied to the cathode 33 and the anode 34, respectively and then the mixed solvent is volatilized in order to form the gel electrolyte layer 36. Then, the cathode lead 31 is mounted on the end of the cathode current collector 33A by welding and the anode lead 32 is mounted on the end of the anode current collector 34A by welding.

Next, the cathode 33 and the anode 34 in which the gel electrolyte layer 36 is formed are laminated via the separator 35. Thus, a layered product is obtained. Then, the layered product is wound in a longitudinal direction and the protective tape 37 is adhered to outermost periphery thereof in order to form the spiral electrode body 30. Finally, for example, the spiral electrode body 30 is sandwiched between the exterior members 40 and then the outer edges of the exterior members 40 are stuck together by heat seal, thereby being sealed. During the process, the adherent film 41 is inserted between the cathode lead 31 and the exterior member 40, and between the anode lead 32 and the exterior member 40. Thus, the secondary battery shown in FIGS. 3 and 4 is obtained.

Alternately, this secondary battery may be produced as follows. First, the cathode 33 and the anode 34 are formed in the same manner as described above. Then, the cathode lead 31 is mounted on the cathode 33 and the anode lead 32 is mounted on the anode 34. Thereafter, the cathode 33 and the anode 34 are laminated via the separator 35 and wound, then the protective tape 37 is adhered to outermost periphery thereof in order to form the spiral electrode body 30. Then, the resulting spiral electrode body 30 is sandwiched between the exterior members 40. Subsequently, the periphery part except one side is sealed by heating so as to form a sac-like structure and housed in the exterior member 40. Then, a composition for electrolyte which contains a solvent, an electrolyte salt, a monomer that is a raw material of a polymeric compound, a polymerization initiator, if necessary, other materials such as a polymerization inhibitor is prepared to be injected into the exterior member 40, which is injected into the inside of the exterior member 40.

After injection of a composition for electrolyte, the opening of the exterior member 40 is sealed by heating under a vacuum atmosphere. Next, in order to form the gel electrolyte layer 36, a monomer is polymerized by heating, which is used as a polymeric compound. The secondary battery shown in FIG. 4 is obtained as described above.

### EXAMPLES

Specific examples will be described with reference to FIGS. 3 and 4. However, the present application is not to be construed as being limited to these examples. In the following description, compounds 12 to 17 are compounds represented by (36-1) to (36-6) in Formula 36 shown below, respectively.

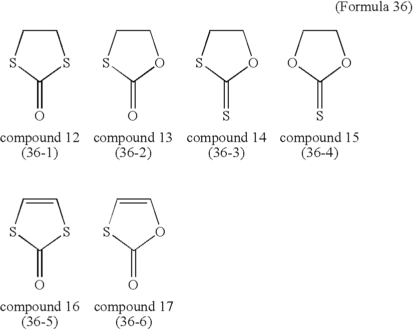

### Examples 1-1 to 1-19, Comparative Examples 1-1 to 1-7

First, lithium carbonate (Li₂CO₃) and cobalt carbonate (CoCO₃) were mixed at the ratio of Li₂CO₃:CoCO₃=0.5:1 (molar ratio), fired at 900° C. for 5 hours in the air to obtain lithium-cobalt composite oxide (LiCoO₂) as a cathode material.

Next, the lithium-cobalt composite oxide of 91 parts by mass, graphite of 6 parts by mass as a conductive agent, polyvinylidene fluoride of 3 parts by mass as a binder were mixed to prepare a cathode mixture. Thereafter, the cathode mixture was dispersed in N-methyl-2-pyrrolidone (NMP) as a solvent, thereby obtaining a cathode mixture slurry. The cathode mixture slurry was uniformly applied over both faces of the cathode current collector 33A made of aluminum foil in a strip shape having a thickness of 12 μm, dried, and compression molded by a roll presser, thereby forming the cathode active material layer 33B and fabricating the cathode 33. After that, the cathode lead 31 made of aluminum was mounted to one end of the cathode current collector 33A.

In addition, artificial graphite powders were prepared as an anode material, and the artificial graphite powders of 90 parts by mass and polyvinylidene fluoride of 10 parts by mass as a binder were mixed to prepare an anode mixture. Then, the anode mixture was dispersed in N-methyl-2-pyrrolidone as a solvent to give an anode mixture slurry. Thereafter, the anode mixture slurry was uniformly applied over both faces of the anode current collector 34A made of a strip shape copper foil having a thickness of 15 μm, dried, compression molded by a roll presser, thereby forming the anode active material layer 34B and fabricating the anode 34. After that, the anode lead 32 made of nickel was mounted to one end of the anode current collector 34A.

Next, the cathode 33 and the anode 34 were laminated via the separator 35 made of a porous polyethylene film and the separator was wound in a flattened form. The resulting spiral electrode body 30 was sandwiched between the exterior members 40 made of a laminate film. The periphery part except one side was sealed by heating so as to form a sac-like structure and housed in the exterior member 40. Then the following electrolytic solution was injected into the inside of the exterior member 40. Then, the opening of the exterior member 40 was sealed by heating under a vacuum atmosphere. As described above, the secondary battery according to Examples 1-1 to 1-19 and Comparative examples 1-1 to 1-7 was produced. A laminate film in which nylon, aluminum, and non-drawn polypropylene were laminated in this order from the outside was used. These thickness values were 30 μm, 40 μm, and 30 μm, respectively and the total thereof was 100 μm.

An electrolytic solution having the composition as shown in Table 1 was used. Here, the concentration of a solvent to which a compound was added was 100% by weight.

The secondary battery produced according to Examples 1-1 to 1-19 and Comparative examples 1-1 to 1-7 was subjected to the charge and discharge test, and then the high temperature storage stability and high temperature cycling characteristics were determined. Two cycles of charge/discharge were carried out at 23° C. and discharging was performed at 23° C. again after charging again and leaving in a thermostat at 80° C. for ten days. Then, the high temperature storage stability was determined by the ratio of the discharge capacity after the storage to the discharge capacity before the storage, namely, (“discharge capacity after storage”/“discharge capacity before storage”)×100. The discharge capacity before the storage is the discharge capacity of the second cycle. The discharge capacity after the storage is the discharge capacity immediately after the storage, in other words, the discharge capacity of the third cycle.

Two cycles of charge/discharge were carried out at 23° C. and then fifty cycles thereof were performed in a thermostat at 60° C. Then, the high temperature storage stability was determined by the ratio of the discharge capacity of the fiftieth cycle at high temperature to the discharge capacity of the second cycle at 23° C., namely, (“discharge capacity of the fiftieth cycle at high temperature”/“discharge capacity of the second cycle at 23° C.”)×100. The obtained results are shown in Table 1.

TABLE 1
SHAPE OF BATTERY: LAMINATE-TYPE
ANODE ACTIVE MATERIAL: ARTIFICIAL GRAPHITE

| | | | | | | | | | DISCHARGE | |
|---|---|---|---|---|---|---|---|---|---|---|
| | | | | | | | | | CAPACITY | |
| | | | | | | | | | MAINTENANCE | |
| | | | | | | | | | RATE (%) | |
| | | | SOLVENT | | | | | | AFTER | CYCLE |
| | LITHIUM SALT | | | | | | | PER- | STORAGE | AT |
| | FIRST | | | | | | | CENT | AT HIGH | HIGH |
| | COM- | SECOND | | | | WEIGHT | | BY | TEMPER- | TEMPER- |
| | POUND | COMPOUND | TYPE | | TYPE | RATIO | TYPE | WEIGHT | ATURE | ATURE |
| EXAMPLE 1-1 | LiPF₆: | — | EC | | DEC | EC:DEC = 2:3 | COMPOUND 12 | 1 | 85 | 72 |
| EXAMPLE 1-2 | 1.0 mol/kg | — | | | | | COMPOUND 15 | 1 | 83 | 71 |
| EXAMPLE 1-3 | | — | | | | | COMPOUND | 1 + 1 | 87 | 82 |
| | | | | | | | 12 + VC | | | |
| EXAMPLE 1-4 | | — | | | | | COMPOUND | 1 + 1 | 86 | 78 |
| | | | | | | | 12 + VEC | | | |
| EXAMPLE 1-5 | | — | | | | | COMPOUND 12 | 0.01 | 82 | 70 |
| EXAMPLE 1-6 | | — | | | | | COMPOUND 12 | 5 | 86 | 70 |
| EXAMPLE 1-7 | LiPF₆: | — | FEC | | DEC | FEC:DEC = 2:3 | COMPOUND 12 | 1 | 88 | 75 |
| EXAMPLE 1-8 | 1.0 mol/kg | — | | | | | COMPOUND 15 | 1 | 86 | 74 |
| EXAMPLE 1-9 | | — | | | | | COMPOUND | 1 + 1 | 89 | 84 |
| | | | | | | | 12 + VC | | | |
| EXAMPLE 1-10 | | — | | | | | COMPOUND | 1 + 1 | 88 | 82 |
| | | | | | | | 12 + VEC | | | |
| EXAMPLE 1-11 | | — | | | | | COMPOUND 12 | 0.01 | 85 | 74 |
| EXAMPLE 1-12 | | — | | | | | COMPOUND 12 | 5 | 89 | 72 |
| EXAMPLE 1-13 | LiPF₆: | — | EC | DFEC | DEC | EC:DFEC:DEC = | COMPOUND 12 | 1 | 89 | 75 |
| EXAMPLE 1-14 | 1.0 mol/kg | — | | | | 2:1:7 | COMPOUND | 1 + 1 | 90 | 84 |
| | | | | | | | 12 + VC | | | |
| EXAMPLE 1-15 | | — | | | | | COMPOUND | 1 + 1 | 90 | 82 |
| | | | | | | | 12 + VEC | | | |

| | | | | | | | | | |
|---|---|---|---|---|---|---|---|---|---|
| EXAMPLE 1-16 | LiPF₆: | FORMULA 22: | EC | DEC | EC:DEC = 2:3 | COMPOUND 12 | 1 | 86 | 73 |
| | 0.9 mol/kg | 0.1 mol/kg | | | | | | | |
| EXAMPLE 1-17 | LiPF₆: | FORMULA 27: | | | | COMPOUND 12 | 1 | 90 | 75 |
| | 0.9 mol/kg | 0.1 mol/kg | | | | | | | |
| EXAMPLE 1-18 | LiPF₆: | FORMULA 32: | | | | COMPOUND 12 | 1 | 87 | 72 |
| | 0.9 mol/kg | 0.1 mol/kg | | | | | | | |
| EXAMPLE 1-19 | LiPF₆: | FORMULA 27: | | | | COMPOUND 12 | 1 | 92 | 78 |
| | 0.8 mol/kg | 0.1 mol/kg | | | | | | | |
| | | FORMULA 32: | | | | | | | |
| | | 0.1 mol/kg | | | | | | | |
| COMPARATIVE | LiPF₆: | — | EC | DEC | EC:DEC = 2:3 | — | — | 81 | 70 |
| EXAMPLE 1-1 | 1.0 mol/kg | | | | | | | | |
| COMPARATIVE | | — | FEC | DEC | FEC:DEC = 2:3 | — | — | 84 | 74 |
| EXAMPLE 1-2 | | | | | | | | | |

| COMPARATIVE | — | EC | DFEC | DEC | EC:DFEC:DEC = | — | — | 85 | 74 |
|---|---|---|---|---|---|---|---|---|---|
| EXAMPLE 1-3 | | | | | 2:1:7 | | | | |
| COMPARATIVE | — | EC | | DEC | EC:DEC = 2:3 | VC | 1 | 82 | 80 |
| EXAMPLE 1-4 | | | | | | | | | |
| COMPARATIVE | — | FEC | | DEC | FEC:DEC = 2:3 | VC | 1 | 85 | 82 |
| EXAMPLE 1-5 | | | | | | | | | |
| COMPARATIVE | — | EC | DFEC | DEC | EC:DFEC:DEC = | VC | 1 | 87 | 82 |
| EXAMPLE 1-6 | | | | | 2:1:7 | | | | |

| | | | | | | | | | |
|---|---|---|---|---|---|---|---|---|---|
| COMPARATIVE | LiPF₆: | FORMULA 22: | EC | DEC | EC:DEC = 2:3 | — | — | 82 | 72 |
| EXAMPLE 1-7 | 0.8 mol/kg | 0.2 mol/kg | | | | | | | |

As shown in Table 1, in Examples 1-1 to 1-19 where an electrolytic solution containing the compound 12 or 15 was used, the high temperature storage stability was improved, while the high temperature cycling characteristics was improved or equal compared to the respective Comparative examples 1-1 to 1-7 where the used electrolytic solution had the same composition except that the compound 12 or 15 was not contained. In other words, it was confirmed that the high temperature characteristics could be improved by using an electrolytic solution containing the compound represented by Formula 5 when a carbon material was used for an anode.

In Example 1-1 where an electrolytic solution containing the compound 12 was used, the high temperature storage stability and high temperature cycling characteristics were improved compared to Example 1-2 where the used electrolytic solution had the same composition except that the compound 15 was contained in place of the compound 12. The same result was obtained when the result of Example 1-7 was compared to that of Example 1-8 in the case of an electrolytic solution containing 4-fluoro-1,3-dioxolane-2-on (FEC). Further, the same result was often obtained when an electrolytic solution containing 4,5-difluoro-1,3-dioxolane-2-on (DFEC) was used. In other words, it was confirmed that the excellent high temperature characteristics could be obtained by using an electrolytic solution containing the compound represented by Formula 9 among the compounds represented by Formula 5 when a carbon material was used for an anode.

In Examples 1-3 and 1-4 where an electrolytic solution containing vinylene carbonate (VC) or vinyl ethylene carbonate (VEC) in addition to the compound 12 was used, the high temperature storage stability and high temperature cycling characteristics were improved compared to Comparative example 1-1 where the used electrolytic solution had the same composition except that the compound 12, vinylene carbonate (VC), and vinyl ethylene carbonate (VEC) were not contained. The same result was obtained when the results of Examples 1-9 and 1-10 were compared to that of Comparative example 1-2 in the case of an electrolytic solution containing 4-fluoro-1,3-dioxolane-2-on (FEC). The same result was obtained when the results of Examples 1-14 and 1-15 were compared to that of Comparative example 1-3 in the case of an electrolytic solution containing 4,5-difluoro-1,3-dioxolane-2-on (DFEC).

In Example 1-3, the high temperature storage stability and high temperature cycling characteristics were improved compared to Example 1-1 where the used electrolytic solution had the same composition except that vinylene carbonate (VC) was not contained and Comparative example 1-4 where the used electrolytic solution had the same composition except that the compound 12 was not contained. The same result was obtained when the result of Example 1-9 was compared to those of Example 1-7 and Comparative example 1-5 in the case of an electrolytic solution containing 4-fluoro-1,3-dioxolane-2-on (FEC). The same result was obtained when the result of Example 1-14 was compared to those of Example 1-13 and Comparative example 1-6 in the case of an electrolytic solution containing 4,5-difluoro-1,3-dioxolane-2-on (DFEC). The same result was often obtained when vinyl ethylene carbonate (VEC) was used. The same result was often obtained when the compounds 13 to 15 was used.

In other words, it was confirmed that the excellent high temperature characteristics could be obtained by using an electrolytic solution containing a cyclic carbonate compound having an unsaturated bond in addition to the compound represented by Formula 5 when a carbon material was used for an anode.

In comparison of Examples 1-1 to 1-6 with Examples 1-7 to 1-12 and Examples 1-13 to 1-15, it was confirmed that the high temperature characteristics could be improved by using an electrolytic solution containing at least one of 4-fluoro-1,3-dioxolane-2-on (FEC) and 4,5-difluoro-1,3-dioxolane-2-on (DFEC) in addition to the compound represented by Formula 5. In other words, it was confirmed that the excellent high temperature characteristics could be obtained by using an electrolytic solution containing the compound represented by Formula 12 in addition to the compound represented by Formula 5 when a carbon material was used for an anode.

As a result of Examples 1-1, 1-5, and 1-6, it was confirmed that the excellent high temperature storage stability and high temperature cycling characteristics could be obtained when the content of the compound 12 was 0.01% by weight or more and less than 5% by weight. The same result was obtained when an electrolytic solution containing 4-fluoro-1,3-dioxolane-2-on (FEC) was used in Examples 1-7, 1-11, and 1-12. The same result was often obtained even when the compounds 13 to 15 were used. In other words, it was found that the content of the compound represented by Formula 5 was preferably 0.01% by weight or more and less than 5% by weight when a carbon material was used for an anode.

In Examples 1-16 to 1-19, it was confirmed that the superior high temperature storage stability and high temperature cycling characteristics can be obtained compared to that of Comparative example 1-1 where an electrolytic solution containing LiPF₆ (the first compound) and a light metal salt of the second compound shown in Table 1 as a lithium salt was used and an electrolytic solution with the same composition except that the compound 12 and the second compound shown in Table 1 were not contained was used.

In Examples 1-16 to 1-19, it was confirmed that the high temperature storage stability and high temperature cycling characteristics were improved or equal compared to Example 1-1 where the used electrolytic solution had the same composition except that the second compound shown in Table 1 as a lithium salt was not contained.

In Example 1-16, it was confirmed that the high temperature storage stability and high temperature cycling characteristics could be further improved compared to Comparative example 1-7 where the used electrolytic solution with the same composition except that the compound 12 was not contained.

As is apparent from the comparison among Examples 1-16 to 1-19, we confirmed that the excellent high temperature storage stability and high temperature cycling characteristics could be obtained in Example 1-19 where an electrolytic solution containing the compound 12 and further containing a light metal salt represented by Formula 27 and a light metal salt represented by Formula 32 was used.

In other words, it was confirmed that the excellent high temperature characteristics could be obtained by using an electrolytic solution containing the compound represented by Formula 5 and further containing at least one of the light metal salt represented by Formula 14 and the light metal salt represented by Formula 30 when a carbon material was used for an anode. Further, it was confirmed that the excellent high temperature characteristics could be obtained by using an electrolytic solution containing the compound represented by Formula 5 and further containing the light metal salt represented by Formula 14 and the light metal salt represented by Formula 30 when a carbon material was used for an anode.

### Examples 2-1 to 2-20 and Comparative Examples 2-1 to 2-7

The secondary battery according to Examples 2-1 to 2-20 and Comparative examples 2-1 to 2-7 was produced in the same manner as Example 1-1 except that an electrolytic solution having the composition as shown in Table 2 was used.

The secondary battery produced according to Examples 2-1 to 2-20 and Comparative examples 2-1 to 2-7 was subjected to the charge and discharge test in the same manner as Example 1-1, and then the high temperature storage stability and high temperature cycling characteristics were determined. The results of measurement are shown in Table 2.

TABLE 2
SHAPE OF BATTERY: LAMINATE-TYPE
ANODE ACTIVE MATERIAL: ARTIFICIAL GRAPHITE

| | | | | | | | | | DISCHARGE | |
|---|---|---|---|---|---|---|---|---|---|---|
| | | | | | | | | | CAPACITY | |
| | | | | | | | | | MAINTENANCE | |
| | | | | | | | | | RATE (%) | |
| | | | SOLVENT | | | | | | AFTER | CYCLE |
| | LITHIUM SALT | | | | | | | PER- | STORAGE | AT |
| | FIRST | | | | | | | CENT | AT HIGH | HIGH |
| | COM- | SECOND | | | | WEIGHT | | BY | TEMPER- | TEMPER- |
| | POUND | COMPOUND | TYPE | | TYPE | RATIO | TYPE | WEIGHT | ATURE | ATURE |
| EXAMPLE 2-1 | LiPF₆: | — | EC | | DEC | EC:DEC = 2:3 | COMPOUND 16 | 1 | 86 | 73 |
| EXAMPLE 2-2 | 1.0 mol/kg | — | | | | | COMPOUND 17 | 1 | 85 | 72 |
| EXAMPLE 2-3 | | — | | | | | COMPOUND | 1 + 1 | 87 | 82 |
| | | | | | | | 16 + VC | | | |
| EXAMPLE 2-4 | | — | | | | | COMPOUND | 1 + 1 | 86 | 78 |
| | | | | | | | 16 + VEC | | | |
| EXAMPLE 2-5 | | — | | | | | COMPOUND 16 | 0.01 | 83 | 70 |
| EXAMPLE 2-6 | | — | | | | | COMPOUND 16 | 5 | 86 | 70 |
| EXAMPLE 2-7 | LiPF₆: | — | FEC | | DEC | FEC:DEC = 2:3 | COMPOUND 16 | 1 | 90 | 76 |
| EXAMPLE 2-8 | 1.0 mol/kg | — | | | | | COMPOUND 17 | 1 | 89 | 75 |
| EXAMPLE 2-9 | | — | | | | | COMPOUND | 1 + 1 | 91 | 84 |
| | | | | | | | 16 + VC | | | |
| EXAMPLE 2-10 | | — | | | | | COMPOUND | 1 + 1 | 90 | 82 |
| | | | | | | | 16 + VEC | | | |
| EXAMPLE 2-11 | | — | | | | | COMPOUND 16 | 0.01 | 85 | 74 |
| EXAMPLE 2-12 | | — | | | | | COMPOUND 16 | 5 | 89 | 72 |
| EXAMPLE 2-13 | LiPF₆: | — | EC | DFEC | DEC | EC:DFEC:DEC = | COMPOUND 16 | 1 | 90 | 76 |
| | | | | | | 2:1:7 | | | | |
| EXAMPLE 2-14 | 1.0 mol/kg | — | | | | | COMPOUND 17 | 1 | 89 | 75 |
| EXAMPLE 2-15 | | — | | | | | COMPOUND | 1 + 1 | 92 | 84 |
| | | | | | | | 16 + VC | | | |
| EXAMPLE 2-16 | | — | | | | | COMPOUND | 1 + 1 | 91 | 82 |
| | | | | | | | 16 + VEC | | | |

| | | | | | | | | | |
|---|---|---|---|---|---|---|---|---|---|
| EXAMPLE 2-17 | LiPF₆: | FORMULA 22: | EC | DEC | EC:DEC = 2:3 | COMPOUND 16 | 1 | 88 | 73 |
| | 0.9 mol/kg | 0.1 mol/kg | | | | | | | |
| EXAMPLE 2-18 | LiPF₆: | FORMULA 27: | | | | COMPOUND 16 | 1 | 92 | 76 |
| | 0.9 mol/kg | 0.1 mol/kg | | | | | | | |
| EXAMPLE 2-19 | LiPF₆: | FORMULA 32: | | | | COMPOUND 16 | 1 | 88 | 72 |
| | 0.9 mol/kg | 0.1 mol/kg | | | | | | | |
| EXAMPLE 2-20 | LiPF₆: | FORMULA 27: | | | | COMPOUND 16 | 1 | 92 | 78 |
| | 0.8 mol/kg | 0.1 mol/kg | | | | | | | |
| | | FORMULA 32: | | | | | | | |
| | | 0.1 mol/kg | | | | | | | |
| COMPARATIVE | LiPF₆: | — | EC | DEC | EC:DEC = 2:3 | — | — | 81 | 70 |
| EXAMPLE 2-1 | 1.0 mol/kg | | | | | | | | |
| COMPARATIVE | | — | FEC | DEC | FEC:DEC = 2:3 | — | — | 84 | 74 |
| EXAMPLE 2-2 | | | | | | | | | |

| COMPARATIVE | — | EC | DFEC | DEC | EC:DFEC:DEC = | — | — | 85 | 74 |
|---|---|---|---|---|---|---|---|---|---|
| EXAMPLE 2-3 | | | | | 2:1:7 | | | | |
| COMPARATIVE | — | EC | | DEC | EC:DEC = 2:3 | VC | 1 | 82 | 80 |
| EXAMPLE 2-4 | | | | | | | | | |
| COMPARATIVE | — | FEC | | DEC | FEC:DEC = 2:3 | VC | 1 | 85 | 82 |
| EXAMPLE 2-5 | | | | | | | | | |
| COMPARATIVE | — | EC | DFEC | DEC | EC:DFEC:DEC = | VC | 1 | 87 | 82 |
| EXAMPLE 2-6 | | | | | 2:1:7 | | | | |

| | | | | | | | | | |
|---|---|---|---|---|---|---|---|---|---|
| COMPARATIVE | LiPF₆: | FORMULA 22: | EC | DEC | EC:DEC = 2:3 | — | — | 82 | 72 |
| EXAMPLE 2-7 | 0.8 mol/kg | 0.2 mol/kg | | | | | | | |

As shown in Table 2, in Examples 2-1 to 2-20 where an electrolytic solution containing the compound 16 or 17 was used, the high temperature storage stability was improved, while the high temperature cycling characteristics was improved or equal compared to the respective Comparative examples 2-1 to 2-7 where the used electrolytic solution had the same composition except that the compound 16 or 17 was not contained.

Further, the same result was often obtained when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the high temperature characteristics could be improved by using an electrolytic solution containing the compound represented by Formula 6 when a carbon material was used for an anode.

In Examples 2-3 and 2-4 where an electrolytic solution containing vinylene carbonate (VC) or vinyl ethylene carbonate (VEC) in addition to the compound 16 was used, the high temperature storage stability and high temperature cycling characteristics were improved compared to Comparative example 2-1 where the used electrolytic solution with the same composition except that the compound 16, vinylene carbonate (VC), and vinyl ethylene carbonate (VEC) were not contained. The same result was obtained when the results of Examples 2-9 and 2-10 were compared to that of Comparative example 2-2 in the case of an electrolytic solution containing 4-fluoro-1,3-dioxolane-2-on (FEC). The same result was obtained when the results of Examples 2-15 and 2-16 were compared to that of Comparative example 2-3 in the case of an electrolytic solution containing 4,5-difluoro-1,3-dioxolane-2-on (DFEC).

In Example 2-3, the high temperature storage stability and high temperature cycling characteristics were improved compared to Example 2-1 where the used electrolytic solution had the same composition except that vinylene carbonate (VC) was not contained and Comparative example 2-4 where an electrolytic solution had the same composition except that the compound 16 was not contained. The same result was obtained when the result of Example 2-9 was compared to those of Example 2-7 and Comparative example 2-5 in the case of an electrolytic solution containing 4-fluoro-1,3-dioxolane-2-on (FEC). The same result was obtained when the result of Example 2-15 was compared to those of Example 2-13 and Comparative example 2-6 in the case of an electrolytic solution containing 4,5-difluoro-1,3-dioxolane-2-on (DFEC). The same result was often obtained even when vinyl ethylene carbonate (VEC) was used.

The same result was obtained even when the compound 17 was used in place of the compound 16. The same result was often obtained even when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the excellent high temperature characteristics could be obtained by using an electrolytic solution containing a cyclic carbonate compound having an unsaturated bond in addition to the compound represented by Formula 6 when a carbon material was used for an anode.

In comparison of Examples 2-1 to 2-6 with Examples 2-7 to 2-12 and Examples 2-13 to 2-16, it was confirmed that the high temperature characteristics could be improved by using an electrolytic solution containing at least one of 4-fluoro-1,3-dioxolane-2-on (FEC) and 4,5-difluoro-1,3-dioxolane-2-on (DFEC) in addition to the compound 16 or 17.

The same result was often obtained even when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the excellent high temperature characteristics could be obtained by using an electrolytic solution containing the compound represented by Formula 12 in addition to the compound represented by Formula 6 when a carbon material was used for an anode.

As a result of Examples 2-1, 2-5, and 2-6, it was confirmed that the excellent high temperature storage stability and high temperature cycling characteristics could be obtained when the content of the compound 16 was 0.01% by weight or more and less than 5% by weight. The same result was obtained when an electrolytic solution containing 4-fluoro-1,3-dioxolane-2-on (FEC) was used in Examples 2-7, 2-11, and 2-12. The same result was often obtained even when the content of the compound 17 was used.

The same result was often obtained even when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was found that the content of the compound represented by Formula 6 was preferably 0.01% by weight or more and less than 5% by weight when a carbon material was used for an anode.

In Examples 2-17 to 2-20 where an electrolytic solution containing the compound 16, further containing LiPF₆ (the first compound) and a light metal salt of the second compound shown in Table 2 as a lithium salt was used, it was confirmed that the superior high temperature storage stability and high temperature cycling characteristics could be obtained compared to that of Comparative example 2-1 where an electrolytic solution with the same composition except that the compound 16 and the second compound shown in Table 2 were not contained was used.

In Examples 2-17 to 2-20, it was confirmed that the high temperature storage stability could be further improved and the high temperature cycling characteristics could be further improved or equal compared to that of Example 2-1 where the used electrolytic solution had the same composition except that the second compound shown in Table 2 as a lithium salt was not contained.

In Example 2-17, it was confirmed that the high temperature storage stability and high temperature cycling characteristics could be further improved compared to Comparative example 2-7 where the used electrolytic solution had the same composition except that the compound 16 was not contained.

As is apparent from the comparison among Examples 2-17 to 2-20, we confirmed that the excellent high temperature storage stability and high temperature cycling characteristics could be obtained in Example 2-20 where an electrolytic solution containing the compound 16 and further containing a light metal salt represented by Formula 22 and a light metal salt represented by Formula 27 was used.

The result was obtained when the compound 17 was used in place of the compound 16. The same result was often obtained even when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the excellent high temperature characteristics could be obtained by using an electrolytic solution containing the compound represented by Formula 6 and further containing at least one of the light metal salt represented by Formula 14 and the light metal salt represented by Formula 30 when a carbon material was used for an anode. Further, it was confirmed that the excellent high temperature characteristics could be obtained by using an electrolytic solution containing the compound represented by Formula 6 and further containing the light metal salt represented by Formula 14 and the light metal salt represented by Formula 30 when a carbon material was used for an anode.

### Examples 3-1 to 3-23 and Comparative Examples 3-1 to 3-7

In order to fabricate the anode 34, the lithium metal having a thickness of 30 μm was attached to the anode current collector 34A made of a strip shaped copper foil having a thickness of 15 μm to form the anode active material layer 34B. An electrolytic solution having the composition as shown in Table 3 was used. The secondary battery according to Examples 3-1 to 3-23 and Comparative examples 3-1 to 3-7 was produced in the same manner as Example 1-1 except the above-mentioned point.

The secondary battery produced according to Examples 3-1 to 3-23 and Comparative examples 3-1 to 3-7 was subjected to the charge and discharge test in the same manner as Example 1-1, and then the high temperature storage stability and high temperature cycling characteristics were determined. The results of measurement are shown in Table 3.

TABLE 3
SHAPE OF BATTERY: LAMINATE-TYPE
ANODE ACTIVE MATERIAL: LITHIUM METAL

| | | | | | | | | | DISCHARGE | |
|---|---|---|---|---|---|---|---|---|---|---|
| | | | | | | | | | CAPACITY | |
| | | | | | | | | | MAINTENANCE | |
| | | | | | | | | | RATE (%) | |
| | | | SOLVENT | | | | | | AFTER | CYCLE |
| | LITHIUM SALT | | | | | | | PER- | STORAGE | AT |
| | FIRST | | | | | | | CENT | AT HIGH | HIGH |
| | COM- | SECOND | | | | WEIGHT | | BY | TEMPER- | TEMPER- |
| | POUND | COMPOUND | TYPE | | TYPE | RATIO | TYPE | WEIGHT | ATURE | ATURE |
| EXAMPLE 3-1 | LiPF₆: | — | EC | | DEC | EC:DEC = 2:3 | COMPOUND 12 | 1 | 86 | 58 |
| EXAMPLE3-2 | 1.0 mol/kg | — | | | | | COMPOUND 13 | 1 | 86 | 58 |
| EXAMPLE3-3 | | — | | | | | COMPOUND 14 | 1 | 82 | 57 |
| EXAMPLE3-4 | | — | | | | | COMPOUND 15 | 1 | 84 | 56 |
| EXAMPLE3-5 | | — | | | | | COMPOUND | 1 + 1 | 88 | 65 |
| | | | | | | | 12 + VC | | | |
| EXAMPLE3-6 | | — | | | | | COMPOUND | 1 + 1 | 87 | 62 |
| | | | | | | | 12 + VEC | | | |
| EXAMPLE3-7 | | — | | | | | COMPOUND 12 | 0.01 | 82 | 56 |
| EXAMPLE3-8 | | — | | | | | COMPOUND 12 | 5 | 88 | 54 |
| EXAMPLE3-9 | LiPF₆: | — | FEC | | DEC | FEC:DEC = 2:3 | COMPOUND 12 | 1 | 88 | 72 |
| EXAMPLE3-10 | 1.0 mol/kg | — | | | | | COMPOUND 13 | 1 | 88 | 72 |
| EXAMPLE3-11 | | — | | | | | COMPOUND 14 | 1 | 86 | 71 |
| EXAMPLE3-12 | | — | | | | | COMPOUND 15 | 1 | 86 | 70 |
| EXAMPLE3-13 | | — | | | | | COMPOUND | 1 + 1 | 90 | 74 |
| | | | | | | | 12 + VC | | | |
| EXAMPLE3-14 | | — | | | | | COMPOUND | 1 + 1 | 89 | 73 |
| | | | | | | | 12 + VEC | | | |
| EXAMPLE3-15 | | — | | | | | COMPOUND 12 | 0.01 | 86 | 70 |
| EXAMPLE3-16 | | — | | | | | COMPOUND 12 | 5 | 86 | 70 |
| EXAMPLE3-17 | LiPF₆: | — | EC | DFEC | DEC | EC:DFEC:DEC = | COMPOUND 12 | 1 | 88 | 73 |
| | | | | | | 2:1:7 | | | | |
| EXAMPLE3-18 | 1.0 mol/kg | — | | | | | COMPOUND | 1 + 1 | 89 | 75 |
| | | | | | | | 12 + VC | | | |
| EXAMPLE3-19 | | — | | | | | COMPOUND | 1 + 1 | 89 | 74 |
| | | | | | | | 12 + VEC | | | |

| | | | | | | | | | |
|---|---|---|---|---|---|---|---|---|---|
| EXAMPLE3-20 | LiPF₆: | FORMULA 22: | EC | DEC | EC:DEC = 2:3 | COMPOUND 12 | 1 | 88 | 78 |
| | 0.9 mol/kg | 0.1 mol/kg | | | | | | | |
| EXAMPLE3-21 | LiPF₆: | FORMULA 27: | | | | COMPOUND 12 | 1 | 90 | 80 |
| | 0.9 mol/kg | 0.1 mol/kg | | | | | | | |
| EXAMPLE3-22 | LiPF₆: | FORMULA 32: | | | | COMPOUND 12 | 1 | 90 | 58 |
| | 0.9 mol/kg | 0.1 mol/kg | | | | | | | |
| EXAMPLE3-23 | LiPF₆: | FORMULA 27: | | | | COMPOUND 12 | 1 | 92 | 83 |
| | 0.8 mol/kg | 0.1 mol/kg | | | | | | | |
| | | FORMULA 32: | | | | | | | |
| | | 0.1 mol/kg | | | | | | | |
| COMPARATIVE | LiPF₆: | — | EC | DEC | EC:DEC = 2:3 | — | — | 80 | 56 |
| EXAMPLE3-1 | 1.0 mol/kg | | | | | | | | |
| COMPARATIVE | | — | FEC | DEC | FEC:DEC = 2:3 | — | — | 84 | 70 |
| EXAMPLE3-2 | | | | | | | | | |

| COMPARATIVE | — | EC | DFEC | DEC | EC:DFEC:DEC = | — | — | 85 | 72 |
|---|---|---|---|---|---|---|---|---|---|
| EXAMPLE3-3 | | | | | 2:1:7 | | | | |
| COMPARATIVE | — | EC | | DEC | EC:DEC = 2:3 | VC | 1 | 81 | 65 |
| EXAMPLE3-4 | | | | | | | | | |
| COMPARATIVE | — | FEC | | DEC | FEC:DEC = 2:3 | VC | 1 | 85 | 71 |
| EXAMPLE3-5 | | | | | | | | | |
| COMPARATIVE | — | EC | DFEC | DEC | EC:DFEC:DEC | VC | 1 | 86 | 73 |
| EXAMPLE3-6 | | | | | 2:1:7 | | | | |

| | | | | | | | | | |
|---|---|---|---|---|---|---|---|---|---|
| COMPARATIVE | LiPF₆: | FORMULA 22: | EC | DEC | EC:DEC = 2:3 | — | — | 85 | 77 |
| EXAMPLE3-7 | 0.8 mol/kg | 0.2 mol/kg | | | | | | | |

As shown in Table 3, in Examples 3-1 to 3-23 where an electrolytic solution containing the compound 12, 13, 14 or 15 was used, the high temperature storage stability was improved, while the high temperature cycling characteristics was improved or equal compared to the respective Comparative examples 3-1 to 3-7 where the used electrolytic solution had the same composition except that the compound 12, 13, 14 or 15 was not contained. In other words, it was confirmed that the high temperature characteristics could be improved by using an electrolytic solution containing the compound represented by Formula 5 when lithium metal was used for an anode active material.

In Example 3-1 where an electrolytic solution containing the compound 12 was used and Example 3-2 where an electrolytic solution containing the compound 13 was used, the high temperature storage stability and high temperature cycling characteristics were improved compared to Example 3-4 where the used electrolytic solution had the same composition except that the compound 14 was contained in place of the compound 12 or 13 and Example 3-3 where the used electrolytic solution had the same composition except that the compound 15 was contained. The same result was obtained when the results of Examples 3-9 and 3-10 were compared to that of Examples 3-11 and 3-12 in the case of an electrolytic solution containing 4-fluoro-1,3-dioxolane-2-on (FEC). Further, the same result was often obtained when an electrolytic solution containing 4,5-difluoro-1,3-dioxolane-2-on (DFEC) was used.

In other words, it was confirmed that the excellent high temperature characteristics could be obtained by using an electrolytic solution containing the compound represented by Formula 9 among the compounds represented by Formula 5 when lithium metal was used for an anode active material.

In Examples 3-5 and 3-6 where an electrolytic solution containing vinylene carbonate (VC) or vinyl ethylene carbonate (VEC) in addition to the compound 12 was used, the high temperature storage stability and high temperature cycling characteristics were improved compared to Comparative example 3-1 where the used electrolytic solution had the same composition except that the compound 12, vinylene carbonate (VC), and vinyl ethylene carbonate (VEC) were not contained.

The same result was obtained when the results of Examples 3-13 and 3-14 were compared to that of Comparative example 3-2 in the case of an electrolytic solution containing 4-fluoro-1,3-dioxolane-2-on (FEC). The same result was obtained when the results of Examples 3-18 and 3-19 were compared to that of Comparative example 3-3 in the case of an electrolytic solution containing 4,5-difluoro-1,3-dioxolane-2-on (DFEC).

In Example 3-5, the high temperature storage stability and high temperature cycling characteristics were improved compared to Example 3-1 where the used electrolytic solution had the same composition except that vinylene carbonate (VC) was not contained. In Example 3-5, the high temperature storage stability was improved and the high temperature cycling characteristics was improved or equal compared to Comparative example 3-4 where the used electrolytic solution had the same composition except that the compound 12 was not contained. In comparison of Example 3-13 (in the case of an electrolytic solution containing 4-fluoro-1,3-dioxolane-2-on (FEC)) with Example 3-9 and Comparative example 3-5, the high temperature storage stability and high temperature cycling characteristics in Example 3-13 were improved compared to Example 3-19 and Comparative example 3-5. In comparison of Example 3-18 (in the case of an electrolytic solution containing 4,5-difluoro-1,3-dioxolane-2-on (DFEC)) with Example 3-17 and Comparative example 3-6, the high temperature storage stability and high temperature cycling characteristics in Example 3-18 were improved compared to Example 3-17 and Comparative example 3-6. The same result was often obtained when vinyl ethylene carbonate (VEC) was used. The same result was often obtained when the compounds 13 to 15 was used in place of the compound 16.

In other words, it was confirmed that the excellent high temperature characteristics could be obtained by using an electrolytic solution containing a cyclic carbonate compound having an unsaturated bond in addition to the compound represented by Formula 5 when lithium metal was used for an anode active material.

In comparison of Examples 3-1 to 3-8 with Examples 3-9 to 3-16 and Examples 3-17 to 3-19, it was confirmed that the high temperature characteristics could be improved by using an electrolytic solution containing at least one of 4-fluoro-1,3-dioxolane-2-on (FEC) and 4,5-difluoro-1,3-dioxolane-2-on (DFEC) in addition to the compound represented by Formula 5. In other words, it was confirmed that the excellent high temperature characteristics could be obtained by using an electrolytic solution containing the compound represented by Formula 12 in addition to the compound represented by Formula 5 when lithium metal was used for an anode active material.

As a result of Examples 3-1, 3-7, and 3-8, it was confirmed that the excellent high temperature storage stability and high temperature cycling characteristics could be obtained when the content of the compound 12 was 0.01% by weight or more and less than 5% by weight. The same result was obtained when an electrolytic solution containing 4-fluoro-1,3-dioxolane-2-on (FEC) was used in Examples 3-9, 3-15, and 3-16. The same result was often obtained even when the content of the compounds 13 to 15 was used. In other words, it was found that the content of the compound represented by Formula 5 was preferably 0.01% by weight or more and less than 5% by weight when lithium metal was used for an anode active material.

In Examples 3-20 to 3-23 where an electrolytic solution containing the compound 12 and further containing LiPF₆ (the first compound) and a light metal salt of the second compound shown in Table 3 as a lithium salt was used, it was confirmed that the superior high temperature storage stability and high temperature cycling characteristics could be obtained compared to that of Comparative example 3-1 where an electrolytic solution with the same composition except that the compound 12 and the second compound shown in Table 3 were not contained was used.

In Examples 3-20 to 3-23, it was confirmed that the high temperature storage stability and high temperature cycling characteristics were further improved or equal compared to that of Example 3-1 where the used electrolytic solution had the same composition except that the second compound shown in Table 3 as a lithium salt was not contained.

In Example 3-20, it was confirmed that the high temperature storage stability and high temperature cycling characteristics could be further improved compared to Example 3-7 where the used electrolytic solution had the same composition except that the compound 12 was not contained.

As is apparent from the comparison among Examples 3-20 to 3-23, we confirmed that the excellent high temperature storage stability and high temperature cycling characteristics could be obtained in Example 3-23 where an electrolytic solution containing the compound 12 and further containing a light metal salt represented by Formula 27 and a light metal salt represented by Formula 32 was used.

In other words, it was confirmed that the excellent high temperature characteristics could be obtained by using an electrolytic solution containing the compound represented by Formula 5 and further containing at least one of the light metal salt represented by Formula 14 and the light metal salt represented by Formula 30 when lithium metal was used for an anode active material. Further, it was confirmed that the excellent high temperature characteristics could be obtained by using an electrolytic solution containing the compound represented by Formula 5 and further containing the light metal salt represented by Formula 14 and the light metal salt represented by Formula 30 when a carbon material was used for an anode.

### Examples 4-1 to 4-20 and Comparative Examples 4-1 to 4-7

An electrolytic solution having the composition as shown in Table 4 was used. The secondary battery according to Examples 4-1 to 4-20 and Comparative examples 4-1 to 4-7 was produced in the same manner as Example 3-1 except the above-mentioned point.

The secondary battery produced according to Examples 4-1 to 4-20 and Comparative examples 4-1 to 4-7 was subjected to the charge and discharge test in the same manner as Example 1-1, and then the high temperature storage stability and high temperature cycling characteristics were determined. The results of measurement are shown in Table 4.

TABLE 4
SHAPE OF BATTERY: LAMINATE-TYPE
ANODE ACTIVE MATERIAL: LITHIUM METAL

| | | | | | | | | | DISCHARGE | |
|---|---|---|---|---|---|---|---|---|---|---|
| | | | | | | | | | CAPACITY | |
| | | | | | | | | | MAINTENANCE | |
| | | | | | | | | | RATE (%) | |
| | | | SOLVENT | | | | | | AFTER | CYCLE |
| | LITHIUM SALT | | | | | | | PER- | STORAGE | AT |
| | FIRST | | | | | | | CENT | AT HIGH | HIGH |
| | COM- | SECOND | | | | WEIGHT | | BY | TEMPER- | TEMPER- |
| | POUND | COMPOUND | TYPE | | TYPE | RATIO | TYPE | WEIGHT | ATURE | ATURE |
| EXAMPLE 4-1 | LiPF₆: | — | EC | | DEC | EC:DEC = 2:3 | COMPOUND 16 | 1 | 88 | 60 |
| EXAMPLE 4-2 | 1.0 mol/kg | — | | | | | COMPOUND 17 | 1 | 87 | 59 |
| EXAMPLE 4-3 | | — | | | | | COMPOUND | 1 + 1 | 90 | 66 |
| | | | | | | | 16 + VC | | | |
| EXAMPLE 4-4 | | — | | | | | COMPOUND | 1 + 1 | 91 | 63 |
| | | | | | | | 16 + VEC | | | |
| EXAMPLE 4-5 | | — | | | | | COMPOUND 16 | 0.01 | 82 | 56 |
| EXAMPLE 4-6 | | — | | | | | COMPOUND 16 | 5 | 88 | 55 |
| EXAMPLE 4-7 | LiPF₆: | — | FEC | | DEC | FEC:DEC = 2:3 | COMPOUND 16 | 1 | 90 | 72 |
| EXAMPLE 4-8 | 1.0 mol/kg | — | | | | | COMPOUND 17 | 1 | 89 | 71 |
| EXAMPLE 4-9 | | — | | | | | COMPOUND | 1 + 1 | 90 | 76 |
| | | | | | | | 16 + VC | | | |
| EXAMPLE 4-10 | | — | | | | | COMPOUND | 1 + 1 | 90 | 74 |
| | | | | | | | 16 + VEC | | | |
| EXAMPLE 4-11 | | — | | | | | COMPOUND 16 | 0.01 | 86 | 70 |
| EXAMPLE 4-12 | | — | | | | | COMPOUND 16 | 5 | 90 | 70 |
| EXAMPLE 4-13 | LiPF₆: | — | EC | DFEC | DEC | EC:DFEC:DEC = | COMPOUND 16 | 1 | 90 | 73 |
| | | | | | | 2:1:7 | | | | |
| EXAMPLE 4-14 | 1.0 mol/kg | — | | | | | COMPOUND 17 | 1 | 89 | 73 |
| EXAMPLE 4-15 | | — | | | | | COMPOUND | 1 + 1 | 92 | 75 |
| | | | | | | | 16 + VC | | | |
| EXAMPLE 4-16 | | — | | | | | COMPOUND | 1 + 1 | 90 | 74 |
| | | | | | | | 16 + VEC | | | |
| EXAMPLE 4-17 | LiPF₆: | FORMULA 22: | EC | | DEC | EC:DEC = 2:3 | COMPOUND 16 | 1 | 90 | 78 |
| | 0.9 mol/kg | 0.1 mol/kg | | | | | | | | |
| EXAMPLE 4-18 | LiPF₆: | FORMULA 27: | | | | | COMPOUND 16 | 1 | 92 | 81 |
| | 0.9 mol/kg | 0.1 mol/kg | | | | | | | | |
| EXAMPLE 4-19 | LiPF₆: | FORMULA 32: | | | | | COMPOUND 16 | 1 | 90 | 58 |
| | 0.9 mol/kg | 0.1 mol/kg | | | | | | | | |
| EXAMPLE 4-20 | LiPF₆: | FORMULA 27: | | | | | COMPOUND 16 | 1 | 93 | 83 |
| | 0.8 mol/kg | 0.1 mol/kg | | | | | | | | |
| | | FORMULA 32: | | | | | | | | |
| | | 0.1 mol/kg | | | | | | | | |
| COMPARATIVE | LiPF₆: | — | EC | | DEC | EC:DEC = 2:3 | — | — | 80 | 56 |
| EXAMPLE 4-1 | 1.0 mol/kg | | | | | | | | | |
| COMPARATIVE | | — | FEC | | DEC | FEC:DEC = 2:3 | — | — | 84 | 70 |
| EXAMPLE 4-2 | | | | | | | | | | |
| COMPARATIVE | | — | EC | DFEC | DEC | EC:DFEC:DEC = | — | — | 85 | 72 |
| EXAMPLE 4-3 | | | | | | 2:1:7 | | | | |
| COMPARATIVE | | — | EC | | DEC | EC:DEC = 2:3 | VC | 1 | 81 | 65 |
| EXAMPLE 4-4 | | | | | | | | | | |
| COMPARATIVE | | — | FEC | | DEC | FEC:DEC = 2:3 | VC | 1 | 85 | 71 |
| EXAMPLE 4-5 | | | | | | | | | | |
| COMPARATIVE | | — | EC | DFEC | DEC | EC:DFEC:DEC = | VC | 1 | 86 | 73 |
| EXAMPLE 4-6 | | | | | | 2:1:7 | | | | |

| | | | | | | | | | |
|---|---|---|---|---|---|---|---|---|---|
| COMPARATIVE | LiPF₆: | FORMULA 22: | EC | DEC | EC:DEC = 2:3 | — | — | 85 | 77 |
| EXAMPLE 4-7 | 0.8 mol/kg | 0.2 mol/kg | | | | | | | |

As shown in Table 4, in Examples 4-1 to 4-20 where an electrolytic solution containing the compound 16 or 17 was used, the high temperature storage stability was improved, while the high temperature cycling characteristics was improved or equal compared to the respective Comparative examples 4-1 to 4-7 where the used electrolytic solution had the same composition except that the compound 16 or 17 was not contained.

The same result was often obtained even when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the high temperature characteristics could be improved by using an electrolytic solution containing the compound represented by Formula 6 when lithium metal was used for an anode active material.

In Examples 4-3 and 4-4 where an electrolytic solution containing vinylene carbonate (VC) or vinyl ethylene carbonate (VEC) in addition to the compound 16 was used, the high temperature storage stability and high temperature cycling characteristics were improved compared to Comparative example 4-1 where the used electrolytic solution had the same composition except that the compound 15, vinylene carbonate (VC), and vinyl ethylene carbonate (VEC) were not contained. The same result was obtained even when the results of Examples 4-9 and 4-10 were compared to that of Comparative example 4-2 in the case of an electrolytic solution containing 4-fluoro-1,3-dioxolane-2-on (FEC). The same result was obtained even when the results of Examples 4-15 and 4-16 were compared to that of Comparative example 4-3 in the case of an electrolytic solution containing 4,5-difluoro-1,3-dioxolane-2-on (DFEC).

In Example 4-3, the high temperature storage stability and high temperature cycling characteristics were improved compared to Example 4-4 where the used electrolytic solution had the same composition except that the case of Example 4-1 where vinylene carbonate (VC) was not contained where the used electrolytic solution had the same composition except that the compound 15 was not contained. The same result was obtained even when the result of Example 4-9 was compared to those of Example 4-7 and Comparative example 4-5 in the case of an electrolytic solution containing 4-fluoro-1,3-dioxolane-2-on (FEC). The same result was obtained even when the result of Example 4-15 was compared to those of Example 4-13 and Comparative example 4-6 in the case of an electrolytic solution containing 4,5-difluoro-1,3-dioxolane-2-on (DFEC). The same result was often obtained when vinyl ethylene carbonate (VEC) was used.

The same result was often obtained when the compound 17 was used in place of the compound 16. The same result was often obtained when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was found that the excellent high temperature characteristics could be obtained by using an electrolytic solution containing a cyclic carbonate compound having an unsaturated bond in addition to the compound represented by Formula 6 when lithium metal was used for an anode active material.

In comparison of Examples 4-1 to 4-6 with Examples 4-7 to 4-12 and Examples 4-13 to 4-16, it was confirmed that the high temperature characteristics could be improved by using an electrolytic solution containing at least one of 4-fluoro-1,3-dioxolane-2-on (FEC) and 4,5-difluoro-1,3-dioxolane-2-on (DFEC) in addition to the compound 16 or 17.

The same result was often obtained when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the excellent high temperature characteristics could be obtained by using an electrolytic solution containing the compound represented by Formula 12 in addition to the compound represented by Formula 6 when a carbon material was used for an anode active material.

As a resule of Examples 4-1, 4-5, and 4-6, it was confirmed that the excellent high temperature storage stability and high temperature cycling characteristics could be obtained when the content of the compound 16 was 0.01% by weight or more and less than 5% by weight. The same result was obtained when an electrolytic solution containing 4-fluoro-1,3-dioxolane-2-on (FEC) was used in Examples 4-7, 4-11, and 4-12. The same result was often obtained even when the content of the compound 17 was used.

The same result was often obtained even when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was found that the content of the compound represented by Formula 6 was preferably 0.01% by weight or more and less than 5% by weight when lithium metal was used for an anode active material.

In Examples 4-17 to 4-20 where an electrolytic solution containing the compound 16 and further containing LiPF₆ (the first compound) and a light metal salt of the second compound shown in Table 4 as a lithium salt was used, it was confirmed that the superior high temperature storage stability and high temperature cycling characteristics could be obtained compared to that of Comparative example 4-1 where an electrolytic solution with the same composition except that the compound 16 and the second compound shown in Table 4 were not contained was used.

In Examples 4-17 to 18 and 4-20, it was confirmed that the high temperature storage stability and high temperature cycling characteristics could be improved more than that of Example 4-1 where the used electrolytic solution had the same composition except that the second compound shown in Table 4 as a lithium salt was not contained. In Example 19, it was confirmed that the high temperature storage stability could be improved more than that of Example 4-1.

In Example 4-17, it was confirmed that the high temperature storage stability and high temperature cycling characteristics could be further improved compared to Comparative example 4-7 where the used electrolytic solution had the same composition except that the compound 16 was not contained.

As is apparent from the comparison among Examples 4-17 to 4-20, we confirmed that the excellent high temperature storage stability and high temperature cycling characteristics could be obtained in Example 4-20 where an electrolytic solution containing the compound 16 and further containing a light metal salt represented by Formula 27 and a light metal salt represented by Formula 32 was used.

The same result was obtained even when the compound 17 was used in place of the compound 16. Further, the same result was often obtained even when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the excellent high temperature characteristics could be obtained by using an electrolytic solution containing the compound represented by Formula 6 and further containing at least one of the light metal salt represented by Formula 14 and the light metal salt represented by Formula 30 when lithium metal was used for an anode active material. Further, it was confirmed that the excellent high temperature characteristics could be obtained by using an electrolytic solution containing the compound represented by Formula 6 and further containing the light metal salt represented by Formula 14 and the light metal salt represented by Formula 30 when a carbon material was used for an anode.

### Examples 5-1 to 5-23 and Comparative Examples 5-1 to 5-7

The anode 34 was fabricated so as to form the anode active material layer 34B on the anode current collector 34A made of copper foil having a thickness of 15 μm by an electron beam evaporation method using silicon (Si) as a anode active material. An electrolytic solution having the composition as shown in Table 5 was used. The secondary battery according to Examples 5-1 to 5-23 and Comparative examples 5-1 to 5-7 was produced in the same manner as Example 1-1 except the above-mentioned point.

The secondary battery produced according to Examples 5-1 to 5-23 and Comparative examples 5-1 to 5-7 was subjected to the charge and discharge test in the same manner as Example 1-1, and then the high temperature storage stability and high temperature cycling characteristics were determined. The results of measurement are shown in Table 5.

TABLE 5
SHAPE OF BATTERY: LAMINATE-TYPE
ANODE ACTIVE MATERIAL: SILICON (Si)

| | | | | | | | | | DISCHARGE | |
|---|---|---|---|---|---|---|---|---|---|---|
| | | | | | | | | | CAPACITY | |
| | | | | | | | | | MAINTENANCE | |
| | | | | | | | | | RATE (%) | |
| | | | SOLVENT | | | | | | AFTER | CYCLE |
| | LITHIUM SALT | | | | | | | PER- | STORAGE | AT |
| | FIRST | | | | | | | CENT | AT HIGH | HIGH |
| | COM- | SECOND | | | | WEIGHT | | BY | TEMPER- | TEMPER- |
| | POUND | COMPOUND | TYPE | | TYPE | RATIO | TYPE | WEIGHT | ATURE | ATURE |
| EXAMPLE 5-1 | LiPF₆: | — | EC | | DEC | EC:DEC = 2:3 | COMPOUND 12 | 1 | 78 | 66 |
| EXAMPLE 5-2 | 1.0 mol/kg | — | | | | | COMPOUND 13 | 1 | 76 | 66 |
| EXAMPLE 5-3 | | — | | | | | COMPOUND 14 | 1 | 76 | 65 |
| EXAMPLE 5-4 | | — | | | | | COMPOUND 15 | 1 | 75 | 65 |
| EXAMPLE 5-5 | | — | | | | | COMPOUND | 1 + 1 | 80 | 68 |
| | | | | | | | 12 + VC | | | |
| EXAMPLE 5-6 | | — | | | | | COMPOUND | 1 + 1 | 79 | 67 |
| | | | | | | | 12 + VEC | | | |
| EXAMPLE 5-7 | | — | | | | | COMPOUND 12 | 0.01 | 72 | 65 |
| EXAMPLE 5-8 | | — | | | | | COMPOUND 12 | 5 | 78 | 65 |
| EXAMPLE 5-9 | LiPF₆: | — | FEC | | DEC | FEC:DEC = 2:3 | COMPOUND 12 | 1 | 84 | 76 |
| EXAMPLE 5-10 | 1.0 mol/kg | — | | | | | COMPOUND 13 | 1 | 83 | 75 |
| EXAMPLE 5-11 | | — | | | | | COMPOUND 14 | 1 | 82 | 75 |
| EXAMPLE 5-12 | | — | | | | | COMPOUND 15 | 1 | 82 | 75 |
| EXAMPLE 5-13 | | — | | | | | COMPOUND 12 | 1 + 1 | 85 | 78 |
| | | | | | | | 12 + VC | | | |
| EXAMPLE 5-14 | | — | | | | | COMPOUND | 1 + 1 | 85 | 77 |
| | | | | | | | 12 + VEC | | | |
| EXAMPLE 5-15 | | — | | | | | COMPOUND 12 | 0.01 | 80 | 75 |
| EXAMPLE 5-16 | | — | | | | | COMPOUND 12 | 5 | 84 | 75 |
| EXAMPLE 5-17 | LiPF₆: | — | EC | DFEC | DEC | EC:DFEC:DEC = | COMPOUND 12 | 1 | 88 | 79 |
| | | | | | | 2:1:7 | | | | |
| EXAMPLE 5-18 | 1.0 mol/kg | — | | | | | COMPOUND | 1 + 1 | 90 | 82 |
| | | | | | | | 12 + VC | | | |
| EXAMPLE 5-19 | | — | | | | | COMPOUND | 1 + 1 | 89 | 79 |
| | | | | | | | 12 + VEC | | | |

| | | | | | | | | | |
|---|---|---|---|---|---|---|---|---|---|
| EXAMPLE 5-20 | LiPF₆: | FORMULA 22: | EC | DEC | EC:DEC = 2:3 | COMPOUND 12 | 1 | 85 | 74 |
| | 0.9 mol/kg | 0.1 mol/kg | | | | | | | |
| EXAMPLE 5-21 | LiPF₆: | FORMULA 27: | | | | COMPOUND 12 | 1 | 89 | 78 |
| | 0.9 mol/kg | 0.1 mol/kg | | | | | | | |
| EXAMPLE 5-22 | LiPF₆: | FORMULA 32: | | | | COMPOUND 12 | 1 | 88 | 72 |
| | 0.9 mol/kg | 0.1 mol/kg | | | | | | | |
| EXAMPLE 5-23 | LiPF₆: | FORMULA 27: | | | | COMPOUND 12 | 1 | 90 | 78 |
| | 0.8 mol/kg | 0.1 mol/kg | | | | | | | |
| | | FORMULA 32: | | | | | | | |
| | | 0.1 mol/kg | | | | | | | |
| COMPARATIVE | LiPF₆: | — | EC | DEC | EC:DEC = 2:3 | — | — | 70 | 65 |
| EXAMPLE 5-1 | 1.0 mol/kg | | | | | | | | |
| COMPARATIVE | | — | FEC | DEC | FEC:DEC = 2:3 | — | — | 78 | 75 |
| EXAMPLE 5-2 | | | | | | | | | |

| COMPARATIVE | — | EC | DFEC | DEC | EC:DFEC:DEC = | — | — | 84 | 78 |
|---|---|---|---|---|---|---|---|---|---|
| EXAMPLE 5-3 | | | | | 2:1:7 | | | | |
| COMPARATIVE | — | EC | | DEC | EC:DEC = 2:3 | VC | 1 | 72 | 70 |
| EXAMPLE 5-4 | | | | | | | | | |
| COMPARATIVE | — | FEC | | DEC | FEC:DEC = 2:3 | VC | 1 | 82 | 76 |
| EXAMPLE 5-5 | | | | | | | | | |
| COMPARATIVE | — | EC | DFEC | DEC | EC:DFEC:DEC = | VC | 1 | 85 | 80 |
| EXAMPLE 5-6 | | | | | 2:1:7 | | | | |

| | | | | | | | | | |
|---|---|---|---|---|---|---|---|---|---|
| COMPARATIVE | LiPF₆: | FORMULA 22: | EC | DEC | EC:DEC = 2:3 | — | — | 80 | 72 |
| EXAMPLE 5-7 | 0.8 mol/kg | 0.2 mol/kg | | | | | | | |

As shown in Table 5, in Examples 5-1 to 5-23 where an electrolytic solution containing the compound 12, 13, 14 or 15 was used, the high temperature storage stability was improved, while the high temperature cycling characteristics was improved or equal compared to the respective Comparative examples 5-1 to 5-7 where the used electrolytic solution had the same composition except that the compound 12, 13, 14 or 15 was not contained. In other words, it was confirmed that the high temperature characteristics could be improved by using an electrolytic solution containing the compound represented by Formula 5 when a material containing silicon (Si) as a constituting element was used for an anode active material.

In Example 5-1 where an electrolytic solution containing the compound 12 was used and Example 5-2 where an electrolytic solution containing the compound 13 was used, the high temperature storage stability was improved or equal and the high temperature cycling characteristics was improved compared to Example 5-3 where the used electrolytic solution had the same composition except that the compound 14 was contained in place of the compound 12 or 13 and Example 5-4 where the used electrolytic solution had the same composition except that the compound 15 was contained. The same result was obtained when the results of Examples 5-9 and 5-10 were compared to that of Examples 5-11 and 5-12 in the case of an electrolytic solution containing 4-fluoro-1,3-dioxolane-2-on (FEC). Further, the same result was often obtained when an electrolytic solution containing 4,5-difluoro-1,3-dioxolane-2-on (DFEC) was used.

In other words, it was confirmed that the excellent high temperature characteristics could be obtained by using an electrolytic solution containing the compound represented by Formula 9 among the compounds represented by Formula 5 when a material containing silicon (Si) as a constituting element was used.

In Examples 5-5 and 5-6 where an electrolytic solution containing vinylene carbonate (VC) or vinyl ethylene carbonate (VEC) in addition to the compound 12 was used, the high temperature storage stability and high temperature cycling characteristics were improved compared to Comparative example 5-1 where the used electrolytic solution had the same composition except that the compound 12, vinylene carbonate (VC), and vinyl ethylene carbonate (VEC) were not contained.

The same result was obtained when the results of Examples 5-13 and 5-14 were compared to that of Comparative example 5-2 in the case of an electrolytic solution containing 4-fluoro-1,3-dioxolane-2-on (FEC). The same result was obtained when the results of Examples 5-18 and 5-19 were compared to that of Comparative example 5-3 in the case of an electrolytic solution containing 4,5-difluoro-1,3-dioxolane-2-on (DFEC).

In Example 5-5, the high temperature storage stability and high temperature cycling characteristics were improved compared to Example 5-1 where the used electrolytic solution had the same composition except that vinylene carbonate (VC) was not contained. In Example 5-5, the high temperature storage stability was improved compared to Comparative example 5-4 where the used electrolytic solution had the same composition except that the compound 12 was not contained. In comparison of Example 5-13 (in the case of an electrolytic solution containing 4-fluoro-1,3-dioxolane-2-on (FEC)) with Example 5-9 and Comparative example 5-5, the high temperature storage stability and high temperature cycling characteristics in Example 5-13 were improved compared to Example 5-9 and Comparative example 5-5. In comparison of Example 5-18 (in the case of an electrolytic solution containing 4,5-difluoro-1,3-dioxolane-2-on (DFEC)) with Example 5-17 and Comparative example 5-6, the high temperature storage stability and high temperature cycling characteristics in Example 5-18 were improved compared to Example 5-17 and Comparative example 5-6. The same result was often obtained when vinyl ethylene carbonate (VEC) was used. The same result was often obtained when the compounds 13 to 15 was used in place of the compound 16.

In other words, it was confirmed that the excellent high temperature characteristics could be obtained by using an electrolytic solution containing a cyclic carbonate compound having an unsaturated bond in addition to the compound represented by Formula 5 when a material containing silicon (Si) as a constituting element was used.

In comparison of Examples 5-1 to 5-8 with Examples 5-9 to 5-16 and Examples 5-17 to 5-19, it was confirmed that the high temperature characteristics could be improved by using an electrolytic solution containing at least one of 4-fluoro-1,3-dioxolane-2-on (FEC) and 4,5-difluoro-1,3-dioxolane-2-on (DFEC) in addition to the compound represented by Formula 5. In other words, it was confirmed that the excellent high temperature characteristics could be obtained by using an electrolytic solution containing the compound represented by Formula 12 in addition to the compound represented by Formula 5 when a material containing silicon (Si) as a constituting element was used.

As a resule of Examples 5-1, 5-7, and 5-8, it was confirmed that the excellent high temperature storage stability and high temperature cycling characteristics could be obtained when the content of the compound 12 was 0.01% by weight or more and less than 5% by weight. The same result was obtained when an electrolytic solution containing 4-fluoro-1,3-dioxolane-2-on (FEC) was used in Examples 5-9, 5-15, and 5-16. The same result was often obtained even when the content of the compounds 13 to 15 was used. In other words, it was found that the content of the compound represented by Formula 5 was preferably 0.01% by weight or more and less than 5% by weight when a material containing silicon (Si) as a constituting element was used.

In Examples 5-20 to 5-23 where an electrolytic solution containing the compound 12 and further containing LiPF₆ as the first compound and a light metal salt of the second compound shown in Table 5 as a lithium salt was used, it was confirmed that the superior high temperature storage stability and high temperature cycling characteristics could be obtained compared to that of Comparative example 5-1 where an electrolytic solution with the same composition except that the compound 12 and the second compound shown in Table 5 were not contained was used.

In Examples 5-20 to 5-23, it was confirmed that the high temperature storage stability and high temperature cycling characteristics could be improved more than that of Example 5-1 where the used electrolytic solution had the same composition except that the second compound shown in Table 5 as a lithium salt was not contained.

In Example 5-20, it was confirmed that the high temperature storage stability and high temperature cycling characteristics could be further improved compared to Example 5-7 where the used electrolytic solution had the same composition except that the compound 12 was not contained.

As is apparent from the comparison among Examples 5-20 to 5-23, we confirmed that the excellent high temperature storage stability and high temperature cycling characteristics could be obtained in Example 5-23 where an electrolytic solution containing the compound 12 and further containing a light metal salt represented by Formula 27 and a light metal salt represented by Formula 32 was used.

In other words, it was found that the excellent high temperature characteristics could be obtained by using an electrolytic solution containing the compound represented by Formula 5 and further containing at least one of the light metal salt represented by Formula 14 and the light metal salt represented by Formula 30 when a material containing silicon (Si) as a constituting element was used for an anode active material. Further, it was found that the excellent high temperature characteristics could be obtained by using an electrolytic solution containing the compound represented by Formula 5 and further containing both the light metal salt represented by Formula 14 and the light metal salt represented by Formula 30.

### Examples 6-1 to 6-20 and Comparative Examples 6-1 to 6-7

An electrolytic solution having the composition as shown in Table 6 was used. The secondary battery according to Examples 6-1 to 6-20 and Comparative examples 6-1 to 6-7 was produced in the same manner as Example 5-1 except the above-mentioned point.

The secondary battery produced according to Examples 6-1 to 6-20 and Comparative examples 6-1 to 6-7 was subjected to the charge and discharge test in the same manner as Example 1-1, and then the high temperature storage stability and high temperature cycling characteristics were determined. The results of measurement are shown in Table 6.

TABLE 6
SHAPE OF BATTERY: LAMINATE-TYPE
ANODE ACTIVE MATERIAL: SILICON (Si)

| | | | | | | | | | DISCHARGE | |
|---|---|---|---|---|---|---|---|---|---|---|
| | | | | | | | | | CAPACITY | |
| | | | | | | | | | MAINTENANCE | |
| | | | | | | | | | RATE (%) | |
| | | | SOLVENT | | | | | | AFTER | CYCLE |
| | LITHIUM SALT | | | | | | | PER- | STORAGE | AT |
| | FIRST | | | | | | | CENT | AT HIGH | HIGH |
| | COM- | SECOND | | | | WEIGHT | | BY | TEMPER- | TEMPER- |
| | POUND | COMPOUND | TYPE | | TYPE | RATIO | TYPE | WEIGHT | ATURE | ATURE |
| EXAMPLE 6-1 | LiPF₆: | — | EC | | DEC | EC:DEC = 2:3 | COMPOUND 16 | 1 | 80 | 68 |
| EXAMPLE 6-2 | 1.0 mol/kg | — | | | | | COMPOUND 17 | 1 | 78 | 67 |
| EXAMPLE 6-3 | | — | | | | | COMPOUND | 1 + 1 | 82 | 70 |
| | | | | | | | 16 + VC | | | |
| EXAMPLE 6-4 | | — | | | | | COMPOUND | 1 + 1 | 81 | 69 |
| | | | | | | | 16 + VEC | | | |
| EXAMPLE 6-5 | | — | | | | | COMPOUND 16 | 0.01 | 72 | 65 |
| EXAMPLE 6-6 | | — | | | | | COMPOUND 16 | 5 | 80 | 64 |
| EXAMPLE 6-7 | LiPF₆: | — | FEC | | DEC | FEC:DEC = 2:3 | COMPOUND 16 | 1 | 86 | 76 |
| EXAMPLE 6-8 | 1.0 mol/kg | — | | | | | COMPOUND 17 | 1 | 85 | 76 |
| EXAMPLE 6-9 | | — | | | | | COMPOUND | 1 + 1 | 88 | 79 |
| | | | | | | | 16 + VC | | | |
| EXAMPLE 6-10 | | — | | | | | COMPOUND | 1 + 1 | 87 | 77 |
| | | | | | | | 16 + VEC | | | |
| EXAMPLE 6-11 | | — | | | | | COMPOUND 16 | 0.01 | 80 | 75 |
| EXAMPLE 6-12 | | — | | | | | COMPOUND 16 | 5 | 84 | 75 |
| EXAMPLE 6-13 | LiPF₆: | — | EC | DFEC | DEC | EC:DFEC:DEC = | COMPOUND 16 | 1 | 89 | 79 |
| | | | | | | 2:1:7 | | | | |
| EXAMPLE 6-14 | 1.0 mol/kg | — | | | | | COMPOUND 17 | 1 | 88 | 79 |
| EXAMPLE 6-15 | | — | | | | | COMPOUND | 1 + 1 | 91 | 82 |
| | | | | | | | 16 + VC | | | |
| EXAMPLE 6-16 | | — | | | | | COMPOUND | 1 + 1 | 91 | 79 |
| | | | | | | | 16 + VEC | | | |

| | | | | | | | | | |
|---|---|---|---|---|---|---|---|---|---|
| EXAMPLE 6-17 | LiPF₆: | FORMULA 22: | EC | DEC | EC:DEC = 2:3 | COMPOUND 16 | 1 | 87 | 74 |
| | 0.9 mol/kg | 0.1 mol/kg | | | | | | | |
| EXAMPLE 6-18 | LiPF₆: | FORMULA 27: | | | | COMPOUND 16 | 1 | 90 | 78 |
| | 0.9 mol/kg | 0.1 mol/kg | | | | | | | |
| EXAMPLE 6-19 | LiPF₆: | FORMULA 32: | | | | COMPOUND 16 | 1 | 88 | 72 |
| | 0.9 mol/kg | 0.1 mol/kg | | | | | | | |
| EXAMPLE 6-20 | LiPF₆: | FORMULA 27: | | | | COMPOUND 16 | 1 | 92 | 78 |
| | 0.8 mol/kg | 0.1 mol/kg | | | | | | | |
| | | FORMULA 32: | | | | | | | |
| | | 0.1 mol/kg | | | | | | | |
| COMPARATIVE | LiPF₆: | — | EC | DEC | EC:DEC = 2:3 | — | — | 70 | 65 |
| EXAMPLE 6-1 | 1.0 mol/kg | | | | | | | | |
| COMPARATIVE | | — | FEC | DEC | FEC:DEC = 2:3 | — | — | 78 | 75 |
| EXAMPLE 6-2 | | | | | | | | | |

| COMPARATIVE | — | EC | DFEC | DEC | EC:DFEC:DEC = | — | — | 84 | 78 |
|---|---|---|---|---|---|---|---|---|---|
| EXAMPLE 6-3 | | | | | 2:1:7 | | | | |
| COMPARATIVE | — | EC | | DEC | EC:DEC = 2:3 | VC | 1 | 72 | 70 |
| EXAMPLE 6-4 | | | | | | | | | |
| COMPARATIVE | — | FEC | | DEC | FEC:DEC = 2:3 | VC | 1 | 82 | 76 |
| EXAMPLE 6-5 | | | | | | | | | |
| COMPARATIVE | — | EC | DFEC | DEC | EC:DFEC:DEC = | VC | 1 | 85 | 80 |
| EXAMPLE 6-6 | | | | | 2:1:7 | | | | |

| | | | | | | | | | |
|---|---|---|---|---|---|---|---|---|---|
| COMPARATIVE | LiPF₆: | FORMULA 22: | EC | DEC | EC:DEC = 2:3 | — | — | 80 | 72 |
| EXAMPLE 6-7 | 0.8 mol/kg | 0.2 mol/kg | | | | | | | |

As shown in Table 6, in Examples 6-1 to 6-20 where an electrolytic solution containing the compound 16 or 17 was used, the high temperature storage stability was improved, while the high temperature cycling characteristics was improved or equal compared to the respective Comparative examples 6-1 to 6-7 in which an electrolytic solution with the same composition except that the compound 16 or 17 was not contained was used.

The same result was often obtained when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the high temperature characteristics could be improved by using an electrolytic solution containing the compound represented by Formula 6 when a material containing silicon (Si) as a constituting element was used for an anode active material.

In Examples 6-3 and 6-4 where an electrolytic solution containing vinylene carbonate (VC) or vinyl ethylene carbonate (VEC) in addition to the compound 16 was used, the high temperature storage stability and high temperature cycling characteristics were improved compared to Comparative example 6-1 where the used electrolytic solution had the same composition except that the compound 16, vinylene carbonate (VC), and vinyl ethylene carbonate (VEC) were not contained. The same result was obtained when the results of Examples 6-9 and 6-10 were compared to that of Comparative example 6-2 in the case of an electrolytic solution containing 4-fluoro-1,3-dioxolane-2-on (FEC). The same result was obtained when the results of Examples 6-15 and 6-16 were compared to that of Comparative example 6-3 in the case of an electrolytic solution containing 4,5-difluoro-1,3-dioxolane-2-on (DFEC).

In Example 6-3, the high temperature storage stability and high temperature cycling characteristics were improved compared to Example 6-1 where the used electrolytic solution had the same composition except that vinylene carbonate (VC) was not contained. In Example 6-3, the high temperature storage stability was improved and the high temperature cycling characteristics was equal compared to Comparative example 6-4 where the used electrolytic solution had the same composition except that the compound 16 was not contained. The same result was obtained when the result of Example 6-9 was compared to those of Example 6-7 and Comparative example 6-5 in the case of an electrolytic solution containing 4-fluoro-1,3-dioxolane-2-on (FEC). The same result was obtained when the result of Example 6-15 was compared to those of Example 6-13 and Comparative example 6-6 in the case of an electrolytic solution containing 4,5-difluoro-1,3-dioxolane-2-on (DFEC). The same result was often obtained even when vinyl ethylene carbonate (VEC) was used.

The same result was often obtained when the compound 17 was used in place of the compound 16. The same result was often obtained when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the excellent high temperature characteristics could be obtained by using an electrolytic solution containing a cyclic carbonate compound having an unsaturated bond in addition to the compound represented by Formula 6 when a material containing silicon (Si) as a constituting element was used for an anode active material.

In comparison of Examples 6-1 to 6-6 with Examples 6-7 to 6-12 and Examples 6-13 to 6-16, it was confirmed that the high temperature characteristics could be improved by using an electrolytic solution containing at least one of 4-fluoro-1,3-dioxolane-2-on (FEC) and 4,5-difluoro-1,3-dioxolane-2-on (DFEC) in addition to the compound 16 or 17.

The same result was often obtained when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the excellent high temperature characteristics could be obtained by using an electrolytic solution containing the compound represented by Formula 12 in addition to the compound represented by Formula 6 when a material containing silicon (Si) as a constituting element was used for an anode active material.

As a result of Examples 6-1, 6-5, and 6-6, it was confirmed that the excellent high temperature storage stability and high temperature cycling characteristics could be obtained when the content of the compound 16 was 0.01% by weight or more and less than 5% by weight. The same result was obtained when an electrolytic solution containing 4-fluoro-1,3-dioxolane-2-on (FEC) was used in Examples 6-7, 6-11, and 6-12. The same result was often obtained even when the content of compound 17 was used.

The same result was often obtained when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was found that the content of the compound represented by Formula 6 was preferably 0.01% by weight or more and less than 5% by weight when a material containing silicon (Si) as a constituting element was used for an anode active material.

In Examples 6-17 to 6-20 where an electrolytic solution containing the compound 16 and further containing LiPF₆ (the first compound) and a light metal salt of the second compound shown in Table 6 as a lithium salt was used, it was confirmed that the superior high temperature storage stability and high temperature cycling characteristics could be obtained compared to that of Comparative example 6-1 where an electrolytic solution with the same composition except that the compound 16 and the second compound shown in Table 6 were not contained was used.

In Examples 6-17 to 6-2, it was confirmed that the high temperature storage stability and high temperature cycling characteristics could be improved more than that of Example 6-1, where the used electrolytic solution had the same composition except that the second compound shown in Table 6 as a lithium salt was not contained.

In Example 6-17, it was confirmed that the high temperature storage stability and high temperature cycling characteristics could be further improved compared to Comparative example 6-7 where the used electrolytic solution had the same composition except that the compound 16 was not contained.

As is apparent from the comparison among Examples 6-17 to 6-20, we confirmed that the excellent high temperature storage stability and high temperature cycling characteristics could be obtained in Example 6-20 where an electrolytic solution containing the compound 16 and further containing a light metal salt represented by Formula 27 and a light metal salt represented by Formula 32 was used.

The same result was often obtained when the compound 17 was used in place of the compound 16. The same result was often obtained when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was found that the excellent high temperature characteristics could be obtained by using an electrolytic solution containing the compound represented by Formula 3 and further containing at least one of the light metal salt represented by Formula 14 and the light metal salt represented by Formula 30 when a material containing silicon (Si) as a constituting element was used for an anode active material. Further, it was confirmed that the excellent high temperature characteristics could be obtained particularly by using an electrolytic solution containing the compound represented by Formula 6 and further containing the light metal salt represented by Formula 14 and the light metal salt represented by Formula 30 when a carbon material was used for an anode.

### Examples 7-1 to 7-10 and Comparative Examples 7-1 to 7-7

In Examples 7-1 to 7-10, the anode 34 was produced as follows. The electrolytic solution as shown in Table 7 was used. The secondary battery according to Examples 7-1 to 7-10 and Comparative examples 7-1 to 7-7 was produced in the same manner as Example 1-1 except the above-mentioned point.

First, cobalt-tin (Co—Sn) alloy powder as a raw material and carbon powder were mixed at a predetermined ratio. The total amount of the powder was 10 g and the mixture was subjected to dry blending. The mixture was placed in a reaction vessel of a planetary ball mill (manufactured by Ito Seisakusho Co., Ltd.) together with about 400 g of corundum having a diameter of 9 mm. The atmosphere in the reaction vessel was replaced by an argon atmosphere. The mill was operated at 250 rpm for 10 minutes and then the operation was posed for 10 minutes, the procedures were repeated until the total of operation time became 20 hours. Thereafter, the reaction vessel was cooled to room temperature and the synthesized anode active material powder was subjected to composition analysis. As a result, the contents of tin (Sn), cobalt (Co), and carbon were 49.5% by mass, 29.7% by mass, and 19.8% by mass, respectively. The ratio of cobalt (Co) to the total of tin (Sn) and cobalt (Co), i.e., Co/(Sn+Co) was 37.5% by mass. The content of carbon was measured by a device for measuring carbon and sulfur and the content of tin (Sn) and cobalt (Co) was measured by Inductively Coupled Plasma optical emission spectrometry (ICP). In X-ray diffraction analysis, a diffraction peak having a half-width of more than 1° was observed in the range 20=20° to 50°. Further, in X-ray Photoelectron Spectroscopy (XPS), a peak P1 as shown in FIG. was observed. When the peak P1 was analyzed, a peak P2 of the surface contamination carbon and a peak P3 of C1s in anode active material powder on the energy side lower than of the peak P2 were obtained. The peak P3 was observed in a region lower than 284.5 eV. In other words, it was confirmed that a carbon in the anode active material powder was bonded to other elements.

Subsequently, anode active material powder of 80 parts by mass, graphite (KS-15 manufactured by Lonza) of 11 parts by mass as a conductive agent, acetylene black of 1 parts by mass, and polyvinylidene fluoride of 8 parts by mass as a binder were mixed, which was dispersed in N-methyl-2-prrrolidone as a solvent to give an anode mixture slurry. Thereafter, the anode mixture slurry was uniformly applied over both faces of the anode current collector 34A made of a strip shaped copper foil having a thickness of 10 μm, dried, compression molded at a constant pressure, thereby forming the anode active material layer 34B. The anode 34 was produced as described above.

The secondary battery produced according to Examples 7-1 to 7-10 and Comparative examples 7-1 to 7-7 was subjected to the charge and discharge test in the same manner as Example 1-1, and then the high temperature storage stability and high temperature cycling characteristics were determined. The results of measurement are shown in Table 7.

TABLE 7
SHAPE OF BATTERY: LAMINATE-TYPE
ANODE ACTIVE MATERIAL: Co—Sn CONTAINED

| | | | | | | | | | DISCHARGE | |
|---|---|---|---|---|---|---|---|---|---|---|
| | | | | | | | | | CAPACITY | |
| | | | | | | | | | MAINTENANCE | |
| | | | | | | | | | RATE (%) | |
| | | | SOLVENT | | | | | | AFTER | CYCLE |
| | LITHIUM SALT | | | | | | | PER- | STORAGE | AT |
| | FIRST | | | | | | | CENT | AT HIGH | HIGH |
| | COM- | SECOND | | | | WEIGHT | | BY | TEMPER- | TEMPER- |
| | POUND | COMPOUND | TYPE | | TYPE | RATIO | TYPE | WEIGHT | ATURE | ATURE |
| EXAMPLE 7-1 | LiPF₆: | — | EC | | DEC | EC:DEC = 2:3 | COMPOUND 12 | 1 | 84 | 66 |
| EXAMPLE 7-2 | 1.0 mol/kg | — | | | | | COMPOUND | 1 + 1 | 85 | 74 |
| | | | | | | | 12 + VC | | | |
| EXAMPLE 7-3 | LiPF₆: | — | FEC | | DEC | FEC:DEC = 2:3 | COMPOUND 12 | 1 | 88 | 82 |
| EXAMPLE 7-4 | 1.0 mol/kg | — | | | | | COMPOUND | 1 + 1 | 90 | 83 |
| | | | | | | | 12 + VC | | | |
| EXAMPLE 7-5 | LiPF₆: | — | EC | DFEC | DEC | EC:DFEC:DEC = | COMPOUND 12 | 1 | 91 | 82 |
| | | | | | | 2:1:7 | | | | |
| EXAMPLE 7-6 | 1.0 mol/kg | — | | | | | COMPOUND | 1 + 1 | 92 | 84 |
| | | | | | | | 12 + VC | | | |

| | | | | | | | | | |
|---|---|---|---|---|---|---|---|---|---|
| EXAMPLE 7-7 | LiPF₆: | FORMULA 22: | EC | DEC | EC:DEC = 2:3 | COMPOUND 12 | 1 | 84 | 76 |
| | 0.9 mol/kg | 0.1 mol/kg | | | | | | | |
| EXAMPLE 7-8 | LiPF₆: | FORMULA 27: | | | | COMPOUND 12 | 1 | 88 | 78 |
| | 0.9 mol/kg | 0.1 mol/kg | | | | | | | |
| EXAMPLE 7-9 | LiPF₆: | FORMULA 32: | | | | COMPOUND 12 | 1 | 88 | 66 |
| | 0.9 mol/kg | 0.1 mol/kg | | | | | | | |
| EXAMPLE 7-10 | LiPF₆: | FORMULA 27: | | | | COMPOUND 12 | 1 | 90 | 79 |
| | 0.8 mol/kg | 0.1 mol/kg | | | | | | | |
| | | FORMULA 32: | | | | | | | |
| | | 0.1 mol/kg | | | | | | | |
| COMPARATIVE | LiPF₆: | — | EC | DEC | EC:DEC = 2:3 | — | — | 76 | 65 |
| EXAMPLE 7-1 | 1.0 mol/kg | | | | | | | | |
| COMPARATIVE | | — | FEC | DEC | FEC:DEC = 2:3 | — | — | 84 | 78 |
| EXAMPLE 7-2 | | | | | | | | | |

| COMPARATIVE | — | EC | DFEC | DEC | EC:DFEC:DEC = | — | — | 86 | 80 |
|---|---|---|---|---|---|---|---|---|---|
| EXAMPLE 7-3 | | | | | 2:1:7 | | | | |
| COMPARATIVE | — | EC | | DEC | EC:DEC = 2:3 | VC | 1 | 76 | 73 |
| EXAMPLE 7-4 | | | | | | | | | |
| COMPARATIVE | — | FEC | | DEC | FEC:DEC = 2:3 | VC | 1 | 86 | 82 |
| EXAMPLE 7-5 | | | | | | | | | |
| COMPARATIVE | — | EC | DFEC | DEC | EC:DFEC:DEC = | VC | 1 | 88 | 82 |
| EXAMPLE 7-6 | | | | 2:1:7 | | | | | |

| | | | | | | | | | |
|---|---|---|---|---|---|---|---|---|---|
| COMPARATIVE | LiPF₆: | FORMULA 22: | EC | DEC | EC:DEC = 2:3 | — | — | 80 | 76 |
| EXAMPLE 7-7 | 0.9 mol/kg | 0.1 mol/kg | | | | | | | |

As shown in Table 7, in Examples 7-1 to 7-10 where an electrolytic solution containing the compound 12 was used, the high temperature storage stability was improved, while the high temperature cycling characteristics was improved or equal compared to the respective Comparative examples 7-1 to 7-7 where the used electrolytic solution had the same composition except that the compound 12 was not contained. In other words, it was confirmed that the high temperature characteristics could be improved by using an electrolytic solution containing the compound represented by Formula 5 when a material containing cobalt and tin as a constituting element was used for an anode active material.

In Example 7-2 where an electrolytic solution containing vinylene carbonate (VC) in addition to the compound 12 was used, the high temperature storage stability and high temperature cycling characteristics were improved compared to Comparative example 7-1 where the used electrolytic solution had the same composition except that the compound 12 and vinylene carbonate (VC) were not contained. The same result was obtained when the result of Example 7-4 was compared to that of Comparative example 7-2 in the case of an electrolytic solution containing 4-fluoro-1,3-dioxolane-2-on (FEC). The same result was obtained when the result of Example 7-6 was compared to that of Comparative example 7-3 in the case of an electrolytic solution containing 4,5-difluoro-1,3-dioxolane-2-on (DFEC).

In Example 7-2, the high temperature storage stability and high temperature cycling characteristics were improved compared to Example 7-1 where the used electrolytic solution had the same composition except that vinylene carbonate (VC) was not contained and Comparative example 7-4 where the used electrolytic solution had the same composition except that the compound 12 was not contained. The same result was obtained when the result of Example 7-4 was compared to those of Example 7-3 and Comparative example 7-5 in the case of an electrolytic solution containing 4-fluoro-1,3-dioxolane-2-on (FEC). The same result was obtained when the result of Example 7-6 was compared to those of Example 7-5 and Comparative example 7-6 in the case of an electrolytic solution containing 4,5-difluoro-1,3-dioxolane-2-on (DFEC). The same result was often obtained when vinyl ethylene carbonate (VEC) was used.

In other words, it was confirmed that the excellent high temperature characteristics could be obtained by using an electrolytic solution containing a cyclic carbonate compound having an unsaturated bond in addition to the compound 12 represented by Formula 5 when a material containing cobalt and tin as a constituting element was used for an anode active material.

In comparison of Examples 7-1 to 7-2 with Examples 7-3 to 7-4 and Examples 7-5 to 7-6, it was confirmed that the high temperature characteristics could be further improved by using an electrolytic solution containing at least one of 4-fluoro-1,3-dioxolane-2-on (FEC) and 4,5-difluoro-1,3-dioxolane-2-on (DFEC) in addition to the compound represented by Formula 5. In other words, it was confirmed that the excellent high temperature characteristics could be obtained by using an electrolytic solution containing the compound represented by Formula 12 in addition to the compound represented by Formula 5 when a material containing cobalt and tin as a constituting element was used for an anode active material.

In Examples 7-7 to 7-10 where an electrolytic solution containing the compound 12 and further containing LiPF₆ (the first compound) and a light metal salt of the second compound shown in Table 7 as a lithium salt was used, it was confirmed that the superior high temperature storage stability and high temperature cycling characteristics could be obtained compared to that of Comparative example 7-1 where an electrolytic solution with the same composition except that the compound 12 and the second compound shown in Table 7 were not contained was used.

In Examples 7-7 to 7-10, it was confirmed that the high temperature storage stability and high temperature cycling characteristics were further improved or equal compared to that of Example 7-1 where the used electrolytic solution had the same composition except that the second compound shown in Table 7 as a lithium salt was not contained.

In Example 7-7, the high temperature storage stability was further improved and the high temperature cycling characteristics was equal compared to Comparative example 7-7 where the used electrolytic solution had the same composition except that the compound 12 was not contained.

As is apparent from the comparison among Examples 7-7 to 7-10, we confirmed that the excellent high temperature storage stability and high temperature cycling characteristics could be obtained in Example 7-10 where an electrolytic solution containing the compound 12 and further containing a light metal salt represented by Formula 27 and a light metal salt represented by Formula 32 was used.

In other words, it was found that the excellent high temperature characteristics could be obtained by using an electrolytic solution containing the compound represented by Formula 5 and further containing at least one of the light metal salt represented by Formula 14 and the light metal salt represented by Formula 30 when a material containing cobalt and tin as a constituting element was used for an anode active material. Further, it was found that the excellent high temperature characteristics could be obtained by using an electrolytic solution containing the compound represented by Formula 5 and further containing both the light metal salt represented by Formula 14 and the light metal salt represented by Formula 30.

As with the case where a carbon material, a lithium metal, and silicon (Si) were used for an anode, the excellent high temperature characteristics was often obtained by using an electrolytic solution containing the compound represented by Formula 9 among the compounds represented by Formula 5 when a material containing silicon (Si) as a constituting element was used when a material containing cobalt and tin as a constituting element was used for an anode active material. As with the case where a carbon material, a lithium metal, and silicon (Si) were used for an anode, the content of the compound represented by Formula 5 was preferably 0.01% by weight or more and less than 5% by weight when a material containing silicon (Si) as a constituting element was used when a material containing cobalt and tin as a constituting element was used for an anode active material.

### Examples 8-1 to 8-10 and Comparative Examples 8-1 to 8-7

An electrolytic solution having the composition as shown in Table 8 was used. The secondary battery according to Examples 8-1 to 8-10 and Comparative examples 8-1 to 8-7 was produced in the same manner as Example 7-1 except the above-mentioned point.

The secondary battery produced according to Examples 8-1 to 8-10 and Comparative examples 8-1 to 8-7 was subjected to the charge and discharge test in the same manner as Example 1-1, and then the high temperature storage stability and high temperature cycling characteristics were determined. The results of measurement are shown in Table 8.

TABLE 8
SHAPE OF BATTERY: LAMINATE-TYPE
ANODE ACTIVE MATERIAL: Co—Sn CONTAINED

| | | | | | | | | | DISCHARGE | |
|---|---|---|---|---|---|---|---|---|---|---|
| | | | | | | | | | CAPACITY | |
| | | | | | | | | | MAINTENANCE | |
| | | | | | | | | | RATE (%) | |
| | | | SOLVENT | | | | | | AFTER | CYCLE |
| | LITHIUM SALT | | | | | | | PER- | STORAGE | AT |
| | FIRST | | | | | | | CENT | AT HIGH | HIGH |
| | COM- | SECOND | | | | WEIGHT | | BY | TEMPER- | TEMPER- |
| | POUND | COMPOUND | TYPE | | TYPE | RATIO | TYPE | WEIGHT | ATURE | ATURE |
| EXAMPLE 8-1 | LiPF₆: | — | EC | | DEC | EC:DEC = 2:3 | COMPOUND 16 | 1 | 86 | 66 |
| EXAMPLE 8-2 | 1.0 mol/kg | — | | | | | COMPOUND | 1 + 1 | 87 | 74 |
| | | | | | | | 16 + VC | | | |
| EXAMPLE 8-3 | LiPF₆: | — | FEC | | DEC | FEC:DEC = 2:3 | COMPOUND 16 | 1 | 90 | 82 |
| EXAMPLE 8-4 | 1.0 mol/kg | — | | | | | COMPOUND | 1 + 1 | 92 | 83 |
| | | | | | | | 16 + VC | | | |
| EXAMPLE 8-5 | LiPF₆: | — | EC | DFEC | DEC | EC:DFEC:DEC = | COMPOUND 16 | 1 | 91 | 82 |
| | | | | | | 2:1:7 | | | | |
| EXAMPLE 8-6 | 1.0 mol/kg | — | | | | | COMPOUND | 1 + 1 | 92 | 84 |
| | | | | | | | 16 + VC | | | |

| | | | | | | | | | |
|---|---|---|---|---|---|---|---|---|---|
| EXAMPLE 8-7 | LiPF₆: | FORMULA 22: | EC | DEC | EC:DEC = 2:3 | COMPOUND 16 | 1 | 84 | 76 |
| | 0.9 mol/kg | 0.1 mol/kg | | | | | | | |
| EXAMPLE 8-8 | LiPF₆: | FORMULA 27: | | | | COMPOUND 16 | 1 | 88 | 78 |
| | 0.9 mol/kg | 0.1 mol/kg | | | | | | | |
| EXAMPLE 8-9 | LiPF₆: | FORMULA 32: | | | | COMPOUND 16 | 1 | 88 | 66 |
| | 0.9 mol/kg | 0.1 mol/kg | | | | | | | |
| EXAMPLE 8-10 | LiPF₆: | FORMULA 27: | | | | COMPOUND 16 | 1 | 90 | 79 |
| | 0.8 mol/kg | 0.1 mol/kg | | | | | | | |
| | | FORMULA 32: | | | | | | | |
| | | 0.1 mol/kg | | | | | | | |
| COMPARATIVE | LiPF₆: | — | EC | DEC | EC:DEC = 2:3 | — | — | 76 | 65 |
| EXAMPLE 8-1 | 1.0 mol/kg | | | | | | | | |
| COMPARATIVE | | — | FEC | DEC | FEC:DEC = 2:3 | — | — | 84 | 78 |
| EXAMPLE 8-2 | | | | | | | | | |

| COMPARATIVE | — | EC | DFEC | DEC | EC:DFEC:DEC = | — | — | 86 | 80 |
|---|---|---|---|---|---|---|---|---|---|
| EXAMPLE 8-3 | | | | | 2:1:7 | | | | |
| COMPARATIVE | — | EC | | DEC | EC:DEC = 2:3 | VC | 1 | 76 | 73 |
| EXAMPLE 8-4 | | | | | | | | | |
| COMPARATIVE | — | FEC | | DEC | FEC:DEC = 2:3 | VC | 1 | 86 | 82 |
| EXAMPLE 8-5 | | | | | | | | | |
| COMPARATIVE | — | EC | DFEC | DEC | EC:DFEC:DEC = | VC | 1 | 88 | 82 |
| EXAMPLE 8-6 | | | | | 2:1:7 | | | | |

| | | | | | | | | | |
|---|---|---|---|---|---|---|---|---|---|
| COMPARATIVE | LiPF₆: | FORMULA 22: | EC | DEC | EC:DEC = 2:3 | — | — | 80 | 76 |
| EXAMPLE 8-7 | 0.9 mol/kg | 0.1 mol/kg | | | | | | | |

As shown in Table 8, in Examples 8-1 to 8-10 where an electrolytic solution containing the compound 16 was used, the high temperature storage stability was improved, while the high temperature cycling characteristics was improved or equal compared to the respective Comparative examples 8-1 to 8-7 where the used electrolytic solution had the same composition except that the compound 16 was not contained.

The same result was often obtained when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the high temperature characteristics could be improved by using an electrolytic solution containing the compound represented by Formula 6 when a material containing cobalt and tin as a constituting element was used for an anode active material.

In Example 8-2 where an electrolytic solution containing vinylene carbonate (VC) in addition to the compound 16 was used, the high temperature storage stability and high temperature cycling characteristics were improved compared to Comparative example 8-1 where the used electrolytic solution had the same composition except that the compound 15 and vinylene carbonate (VC) were not contained. The same result was obtained when the result of Example 8-4 was compared to that of Comparative example 8-2 in the case of an electrolytic solution containing 4-fluoro-1,3-dioxolane-2-on (FEC). The same result was obtained when the result of Example 8-6 was compared to that of Comparative example 8-3 in the case of an electrolytic solution containing 4,5-difluoro-1,3-dioxolane-2-on (DFEC).

In Example 8-2, the high temperature storage stability and high temperature cycling characteristics were improved compared to Example 8-1 where the used electrolytic solution had the same composition except that vinylene carbonate (VC) was not contained and Comparative example 8-4 where the used electrolytic solution had the same composition except that the compound 16 was not contained. The same result was obtained when the result of Examples 8-4 was compared to those of Example 8-3 and Comparative example 8-5 in the case of an electrolytic solution containing 4-fluoro-1,3-dioxolane-2-on (FEC). The same result was obtained when the result of Examples 8-6 was compared to those of Example 8-5 and Comparative example 8-6 in the case of an electrolytic solution containing 4,5-difluoro-1,3-dioxolane-2-on (DFEC). The same result was often obtained when vinyl ethylene carbonate (VEC) was used.

The same result was obtained when the compound 17 was used in place of the compound 16. Further, the same result was often obtained when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the excellent high temperature characteristics could be obtained by using an electrolytic solution containing a cyclic carbonate compound having an unsaturated bond in addition to the compound 16 represented by Formula 6 when a material containing cobalt and tin as a constituting element was used for an anode active material.

In comparison of Examples 8-1 to 8-2 with Examples 8-3 to 8-4 and Examples 8-5 to 8-6, it was confirmed that the high temperature characteristics could be improved by using an electrolytic solution containing at least one of 4-fluoro-1,3-dioxolane-2-on (FEC) and 4,5-difluoro-1,3-dioxolane-2-on (DFEC) in addition to the compound 16.

The same result was often obtained when the compound 17 was used in place of the compound 16. The same result was often obtained when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was confirmed that the excellent high temperature characteristics could be obtained by using an electrolytic solution containing the compound represented by Formula 12 in addition to the compound represented by Formula 6 when a material containing cobalt and tin as a constituting element was used for an anode active material.

Examples 8-7 to 8-10, it was confirmed that the superior high temperature storage stability and high temperature cycling characteristics could be obtained compared to that of Comparative example 8-1 where an electrolytic solution containing the compound 16 and further containing LiPF₆ (the first compound) and a light metal salt of the second compound shown in Table 8 as a lithium salt was used and an electrolytic solution with the same composition except that the compound 16 and the second compound shown in Table 8 were not contained was used.

In Examples 8-7 to 8-10, it was confirmed that the high temperature storage stability could be further improved and the high temperature cycling characteristics could be further improved or equal compared to that of Example 8-1 where the used electrolytic solution had the same composition except that the second compound shown in Table 8 as a lithium salt was not contained.

In Example 8-7, it was confirmed that the high temperature storage stability could be further improved and the high temperature cycling characteristics could be further improved or equal compared to Comparative example 8-7 where the used electrolytic solution had the same composition except that the compound 16 was not contained.

As is apparent from the comparison among Examples 8-7 to 8-10, we confirmed that the excellent high temperature storage stability and high temperature cycling characteristics could be obtained in Example 8-10 where an electrolytic solution containing the compound 16 and further containing a light metal salt represented by Formula 27 and a light metal salt represented by Formula 32 was used.

The same result was often obtained when the compound 17 was used in place of the compound 16. The same result was often obtained when the compound represented by (8-15) in Formula 8 having a fluorine group, the compound represented by (8-22) in Formula 8 having a bromo group, the compound represented by (8-14) in Formula 8 having a fluorine group, and the compound represented by (8-20) in Formula 8 having a bromo group were used in place of the compound 16.

In other words, it was found that the high temperature storage stability and high temperature cycling characteristics could be improved by using an electrolytic solution containing the compound represented by Formula 6 and further containing at least one of the light metal salt represented by Formula 14 and the light metal salt represented by Formula 30 when a material containing cobalt and tin as a constituting element was used for an anode active material. Further, it was found that the excellent high temperature characteristics could be obtained by using an electrolytic solution containing the compound represented by Formula 6 and further containing the light metal salt represented by Formula 14 and the light metal salt represented by Formula 30.

As with the case where a carbon material, a lithium metal, and silicon (Si) were used for an anode, the content of the compound represented by Formula 6 was preferably 0.01% by weight or more and less than 5% by weight when a material containing silicon (Si) as a constituting element was used when a material containing cobalt and tin as a constituting element was used for an anode active material.

A battery was produced in the same manner as examples described above using an electrolytic solution which contained the compound represented by (8-3) of Formula 8 in place of the compound 16 and the high temperature storage stability and high temperature cycling characteristics was determined, which was compared. As a result, the battery produced by using the electrolytic solution containing the compound 16 could provide more excellent high temperature storage stability and high temperature cycling characteristics compared to the battery produced by using the electrolytic solution containing the compound represented by (8-3) of Formula 8. In other words, it was found that the excellent high temperature characteristics was often obtained by using an electrolytic solution containing the compound represented by Formula 10 among the compounds represented by Formula 6.

Although the above-mentioned examples concern the case where an electrolytic solution is used, the same result can be obtained even when a gel-like electrolyte is used.

As described above, according to the application it was confirmed that the high temperature characteristics could be improved by using an electrolyte containing at least one of the compound represented by Formulae 5 and 6 in the overall anode. In the overall anode, it was found that the excellent high temperature characteristics was often obtained by using an electrolyte containing the compound represented by Formula 9 among the compounds represented by Formula 5. Additionally, in the overall anode, it was found that the excellent high temperature characteristics could be obtained by using an electrolyte containing a cyclic carbonate compound having an unsaturated bond in addition to at least one of the compound represented by Formulae 5 and 6. Further, it was found that the excellent high temperature characteristics could be obtained by using an electrolyte containing the compound represented by Formula 12 in addition to at least one of the compound represented by Formulae 5 and 6. In the overall anode, it was confirmed that the content of at least one of a compound represented by Formula 5 or Formula 6 was preferably 0.01% by weight or more and less than 5% by weight to a solvent from a viewpoint that more excellent high temperature characteristics could be obtained. In the overall anode, it was confirmed that the excellent high temperature characteristics could be obtained by using an electrolyte containing at least one of the compound represented by Formulae 5 and 6 and further containing at least one of the light metal salt represented by Formula 14 and the light metal salt represented by Formula 30 as an electrolyte salt. Additionally, it was confirmed that the excellent high temperature characteristics could be obtained by using an electrolyte containing at least one of the compound represented by Formulae 5 and 6 and further containing both the light metal salt represented by Formula 14 and the light metal salt represented by Formula 30. Further, it was found that the excellent high temperature characteristics was often obtained by using an electrolyte containing the compound represented by Formula 10 among the compounds represented by Formula 6.

The present application is not to be limited by the embodiments and examples described herein and various modifications of the application can be made without departing from its spirit and scope. For example, the secondary battery having a winding structure was illustrated in the above-mentioned embodiments and examples. However, the application is applicable to a secondary battery having a square shape, a sheet shape, a card shape, or a laminated structure in which one or more cathodes and anodes are laminated. Further, the application can be applied to not only the secondary battery but also other batteries such as a primary battery.

In the embodiments described above, the battery having a cylindrical shape and the battery in which a laminate film is used as an exterior material are illustrated, but it is not limited thereto. The application can be applied to, for example, a coin type battery, a square type battery, a button type battery, a battery in which a metal container is used as an exterior member, a thin type battery, and nonaqueous electrolyte batteries of various shapes and sizes.

The case where lithium is used as an anode active material is illustrated in the above-mentioned embodiments and examples. The application can be applied to the case where other elements of Group 1 in the long-form periodic table such as sodium (Na) or potassium (K), elements of Group 2 in the long-form periodic table such as magnesium (Mg) or calcium (Ca), other light metals such as aluminum (Al), or lithium (Li) or alloys thereof is used and the same effect can be obtained. In that case, as an anode active material, the above-mentioned anode material can be used in the same manner as described above.

It should be understood by those skilled in the art that various modifications, combinations, sub-combinations and alternations may occur depending on design requirements and other factors insofar as they are within the scope of the appended claims or the equivalents thereof.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An electrolyte comprising at least one of a compound represented by Formula 1 or 2, 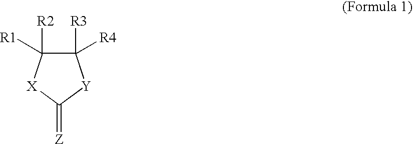
wherein, R1, R2, R3, and R4 represent a hydrogen group, or a methyl group and an ethyl group; X, Y, and Z represent sulfur or oxygen, not including X═Y=Z=S and X═Y=Z=O, and 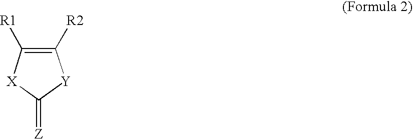
wherein, R1 and R2 represent a hydrogen group, a halogen group, or a methyl group and an ethyl group, or groups in which a part of hydrogen thereof is substituted by a halogen group; X, Y, and Z represent sulfur or oxygen, not including X═Y=Z=S and X═Y=Z=O.

2. The electrolyte according to claim 1, wherein a compound represented by the Formula 1 is represented by Formula 3 in which at least one of X and Y is sulfur and Z is oxygen in the Formula 1, and a compound represented by the Formula 2 is represented by Formula 4 in which at least one of X and Y is sulfur and Z is oxygen in the Formula 2: 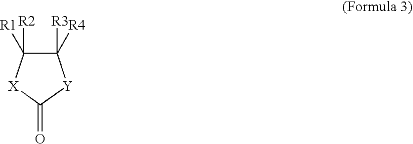
wherein, R1, R2, R3, and R4 represent a hydrogen group, or a methyl group and an ethyl group; X and Y represent sulfur or oxygen, not including X═Y=O, and 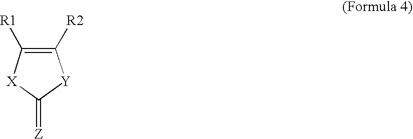
wherein, R1 and R2 represent a hydrogen group, a halogen group, or a methyl group and an ethyl group, or groups in which a part of hydrogen thereof is substituted by a halogen group; X and Y represent sulfur or oxygen, not including X═Y═O.

3. The electrolyte according to claim 1, wherein a content of the compound is 0.01% by weight or more and less than 5% by weight to a solvent.

4. The electrolyte according to claim 1, further comprising a cyclic carbonate compound having an unsaturated bond.

5. The electrolyte according to claim 1, further comprising at least one of a compound represented by Formula 5, 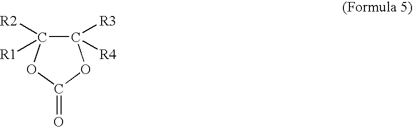
wherein, R1, R2, R3, and R4 represent a hydrogen group, a halogen group, or a methyl group and an ethyl group, or groups in which a part of hydrogen thereof is substituted by a halogen group, and at least one group thereof has a halogen group.

6. The electrolyte according to claim 1, further comprising at least one of 4-fluoro-1,3-dioxolane-2-on and 4,5-difluoro-1,3-dioxolane-2-on.

7. The electrolyte according to claim 1, further comprising at least one of a light metal salt represented by Formula 6, 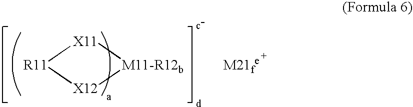
wherein, R11 represents a —C(═O)—R21-C(═O)-group, where R21 is an alkylene group, an alkylene halide group, an arylene group, or a arylene halide group, a —C(═O)—C(R23)(R24)-group, where R23 and R24 represent an alkyl group, an alkyl halide group, an aryl group, or an aryl halide group, or a —C(═O)—C(═O)-group; R12 represents a halogen group, an alkyl group, an alkyl halide group, an aryl group, or an aryl halide group; X11 and X12 represent oxygen or sulfur, respectively; M11 represents a transition metal element or an element of Group 3B, 4B or 5B in the short-form periodic table; M21 represents an element of Group 1A or 2A in the short-form periodic table, or an aluminum; a is an integer of 1 to 4; b is an integer of 0 to 8; c, d, e, and f are integers of 1 to 3, respectively.

8. The electrolyte according to claim 1, further comprising at least one of a light metal salt represented by Formula 7, 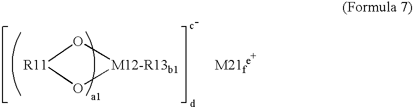
wherein, R11 represents a —C(═O)—R21-C(═O)-group, where R21 is an alkylene group, an alkylene halide group, an arylene group, or a arylene halide group, a —C(═O)—C(═O)-group or a —C(═O)—C—(R22)₂, where (R22 represents an alkyl group, an alkyl halide group, an aryl group, or aryl halide group; R13 represents halogen; M12 represents phosphorus or boron; M21 represents an element of Group 1A or 2A in the short-form periodic table, or an aluminum; a1 is an integer of 1 to 4; b1 is an integer of 0, 2 or 4; c, d, e, and f are integers of 1 to 3, respectively.

9. The electrolyte according to claim 1, comprising at least one of a light metal salt selected from the group consisting of lithium difluoro[oxolato-O,O′]phosphate represented by Formula 8, lithium difluorobis[oxolato-O,O′]phosphate represented by Formula 9, lithium difluoro[3,3,3-trifluoro-2-oxide-2-trifluoromethylpropionate(2-)-O,O′]phosphate represented by Formula 10, lithium bis[3,3,3-trifluoro-2-oxide 2-trifluoromethylpropionate(2-)-O,O′]phosphate represented by Formula 11, lithium tetrafluoro[oxolato-O,O′]phosphate represented by Formula 12, lithium bis[oxolato-O,O′]phosphate represented by Formula 13:

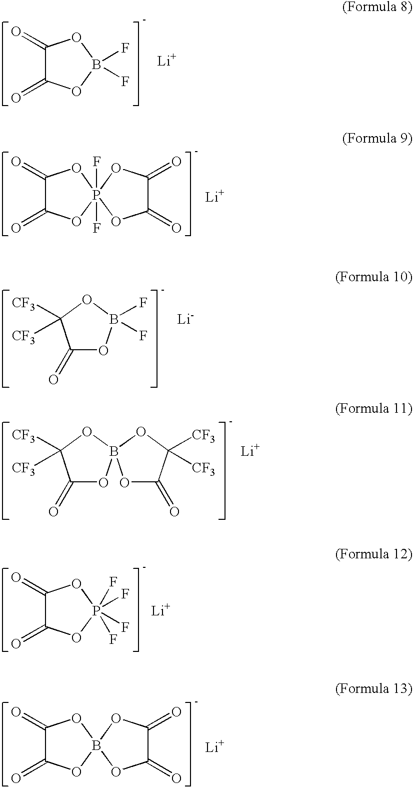

10. The electrolyte according to claim 1, further comprising at least one selected from the group consisting of a lithium salt represented by LiPF₆, LiBF₄, LiClO₄, LiAsF₆, and Formula 14, a lithium salt represented by Formula 15, and a lithium salt represented by Formula 16:
LiN(CₘF₂ₘ₊₁SO₂)(CₙF₂ₙ₊₁SO₂) (Formula 14)
wherein, m and n are one or more integers, 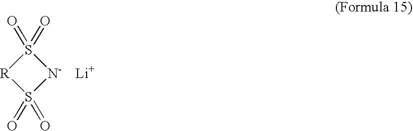
wherein, R represents a linear or branched perfluoro alkylene group having 2 to 4 carbon atoms, and
LiC(CₚF₂ₚ₊₁SO₂)(C_{q}F_{2q+1}SO₂)(CᵣF₂ᵣ₊₁SO₂) (Formula 16)
wherein, p, q, and r are one or more integers.

11. A battery comprising a cathode and an anode, and an electrolyte, wherein the electrolyte includes at least one of a compound represented by Formula 17 and a compound represented by Formula 18: 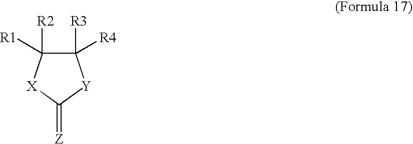
wherein, R1, R2, R3, and R4 represent a hydrogen group, or a methyl group and an ethyl group; X, Y, and Z represent sulfur or oxygen, not including X═Y=Z=S and X═Y=Z=O, and 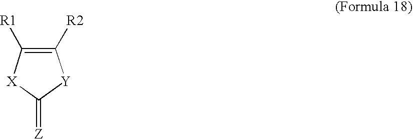
wherein, R1 and R2 represent a hydrogen group, a halogen group, or a methyl group and an ethyl group, or groups in which a part of hydrogen thereof is substituted by a halogen group; X, Y, and Z represent sulfur or oxygen, not including X═Y=Z=S and X═Y=Z=O.

12. The battery according to claim 11, wherein a compound represented by the Formula 17 is represented by Formula 19 in which at least one of X and Y is sulfur and Z is oxygen in the Formula 17, and a compound represented by the Formula 18 is represented by Formula 20 in which at least one of X and Y is sulfur and Z is oxygen in the Formula 18, 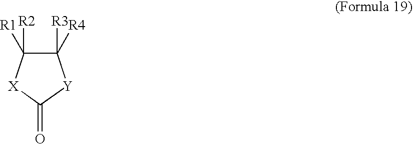
wherein, R1, R2, R3, and R4 represent a hydrogen group, or a methyl group and an ethyl group; X and Y represent sulfur or oxygen, not including X═Y═O, and 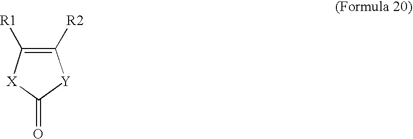
wherein, R1 and R2 represent a hydrogen group, a halogen group, or a methyl group and an ethyl group, or groups in which a part of hydrogen thereof is substituted by a halogen group; X and Y represent sulfur or oxygen, not including X═Y═O.

13. The battery according to claim 11, wherein a content of the compound is 0.01% by weight or more and less than 5% by weight to a solvent.

14. The battery according to claim 11, wherein the electrolyte further comprises a cyclic carbonate compound having an unsaturated bond.

15. The battery according to claim 11, wherein the electrolyte further comprises at least one of a compound represented by Formula 21: 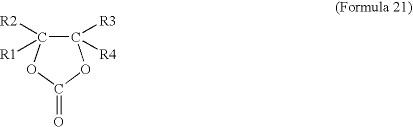
wherein, R1, R2, R3, and R4 represent a hydrogen group, a halogen group, or a methyl group and an ethyl group, or groups in which a part of hydrogen thereof is substituted by a halogen group and at least one group thereof has a halogen group.

16. The battery according to claim 11, wherein the electrolyte further comprises at least one of 4-fluoro-1,3-dioxolane-2-on and 4,5-difluoro-1,3-dioxolane-2-on.

17. The battery according to claim 11, wherein the electrolyte further comprises at least one of a light metal salt represented by Formula 22: 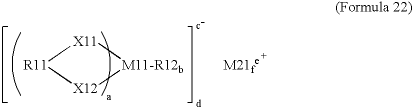
wherein, R11 represents a —C(═O)—R21-C(═O)-group where R21 is an alkylene group, an alkylene halide group, an arylene group, or a arylene halide group, a —C(═O)—C(R23)(R24)-group; where R23 and R24 represent an alkyl group, an alkyl halide group, an aryl group, or an aryl halide group, or a —C(═O)—C(═O)-group; R12 represents a halogen group, an alkyl group, an alkyl halide group, an aryl group, or an aryl halide group; X11 and X12 represent oxygen or sulfur, respectively; M11 represents a transition metal element or an element of Group 3B, 4B or 5B in the short-form periodic table; M21 represents an element of Group 1A or 2A in the short-form periodic table, or an aluminum; a is an integer of 1 to 4; b is an integer of 0 to 8; c, d, e, and f are integers of 1 to 3, respectively.

18. The battery according to claim 11, wherein the electrolyte further comprises at least one of a light metal salt represented by Formula 23: 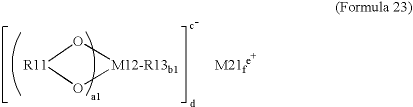
wherein, R11 represents a —C(═O)—R21-C(═O)-group, R21 is an alkylene group, an alkylene halide group, an arylene group, or a arylene halide group, a —C(═O)—C(═O)-group or a —C(═O)—C—(R22)₂, where R22 represents an alkyl group, an alkyl halide group, an aryl group, or aryl halide group; R13 represents halogen; M12 represents phosphorus or boron; M21 represents an element of Group 1A or 2A in the short-form periodic table, or an aluminum; a1 is an integer of 1 to 4; b1 is an integer of 0, 2 or 4; c, d, e, and f are integers of 1 to 3, respectively.

19. The battery according to claim 11, wherein the electrolyte comprises at least one of a light metal salt selected from the group consisting of lithium difluoro[oxolato-O,O′]phosphate represented by Formula 24, lithium difluorobis[oxolato-O,O′]phosphate represented by Formula 25, lithium difluoro[3,3,3-trifluoro-2-oxide 2-trifluoromethylpropionate(2-)-O,O′]phosphate represented by Formula 26, lithium bis[3,3,3-trifluoro-2-oxide 2-trifluoromethylpropionate(2-)-O,O′]represented by Formula 27, lithium tetrafluoro[oxolato-O,O′]phosphate represented by Formula 28, lithium bis[oxolato-O,O′]phosphate represented by Formula 29:

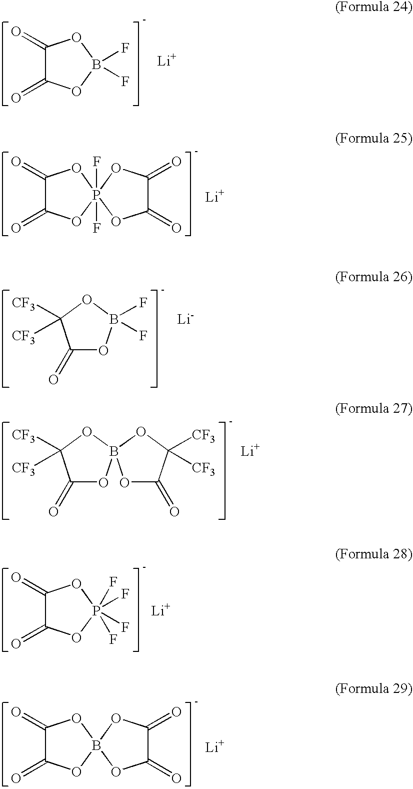

20. The battery according to claim 11, wherein the electrolyte comprises at least one selected from the group consisting of a lithium salt represented by LiPF₆, LiBF₄, LiClO₄, LiAsF₆, and Formula 30, a lithium salt represented by Formula 31, a lithium salt represented by Formula 32:
LiN(CₘF₂ₘ₊₁SO₂)(CₙF₂ₙ₊₁SO₂) (Formula 30)
wherein, m and n are one or more integers, 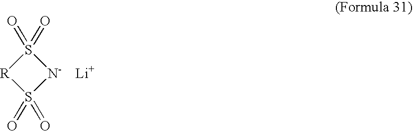
wherein, R represents a linear or branched perfluoro alkylene group having 2 to 4 carbon atoms, and
LiC(CₚF₂ₚ₊₁SO₂)(C_{q}F_{2q+1}SO₂)(CᵣF₂ᵣ₊₁SO₂) (Formula 32)
wherein, p, q, and r are one or more integers.
